(19) United States
(12) Patent Application Publication
(10) Pub. No.: US 2024/0394421 A1
(43) Pub. Date: Nov. 28, 2024

(54) SERVERS, SYSTEMS, AND METHODS FOR CONTROLLING DESIGN ENVIRONMENT LOGIC IN MODELING SOFTWARE USING EXTERNALLY DEFINED VOCABULARY

(71) Applicant: Aveva Software, LLC, Lake Forest, CA (US)

(72) Inventors: David Barker, Suffolk (GB); Allison Orton, Cambridge (GB); Ajay Paul Singh Brar, Melbourne (AU)

(21) Appl. No.: 18/422,804

(22) Filed: Jan. 25, 2024

Related U.S. Application Data
(60) Provisional application No. 63/441,093, filed on Jan. 25, 2023.

(51) Int. Cl. G06F 30/10; G06F 111/20

(52) U.S. Cl. CPC G06F 30/10; G06F 2111/20

(57) ABSTRACT

In some embodiments, the disclosure is directed to a system for controlling links between entities in a design environment. In some embodiments, the system is configured to enable a user to define attributes for a generic entity without editing the generic entity. In some embodiments, the system is configured to store the defined attributes separately from the generic entity. In some embodiments, the system is configured to execute and association between the generic entity and the attributes to create a specific entity. In some embodiments, the system is configured to prevent connection between specific entities that do not share at least one common attribute. In some embodiments, the system is configured to automatically assign attributes to linked generic entities when at least one attribute is assigned to at least one linked generic entity.

### REFERENCE TO RELATED APPLICATION

This application claims the benefit of priority from U.S. Provisional Application No. 63/441,093, filed Jan. 25, 2023, entitled “SERVERS, SYSTEMS, AND METHODS FOR CONTROLLING MODELING LOGIC,” which is incorporated herein by reference in its entirety.

### BACKGROUND OF THE INVENTION

Prior art systems only provide fixed data models that do not allow for customization of entities in a design environment. Using cables as an example, in prior art system the generic entity may be labeled “cable” but there may also be several other entities with the same “cable” designation in a design library, and while they share the same name, one may refer to a mechanical cable while the other to an electrical cable. Another example may be a 2″ cable and a 1″ cable. Some entity labels can be referenced in multiple languages. Determining which “cable” is appropriate to use to connect to other entities (e.g., junction boxes, sensors) within a conceptual model is not evident within prior art design environment logic. This often results in incorrect components being introduced into a conceptual model which is sometimes not discovered until actual construction of an industrial facility, costing time and precious resources to correct. There is currently no way to verify connection between entities in the design environment, or ways to create verification links between data models.

Therefore, there is a need in the art for a system that can add attributes to a fixed entity in a data modeling software design environment using one or more external customizable files where entity attributes can be assigned and/or controlled using design environment logic.

### SUMMARY OF THE INVENTION

In some embodiments, the system allows for the creation of a flexible user defined conceptual model in a design environment, so that an end user can create a model that suits their needs. In some embodiments, the system is configured to be integrated into a modeling software (e.g., AVEVA® Engineering) and includes a design environment to create and/or store one or more conceptual models and/or one or more data models. In some embodiments, a conceptual model is created by a user in the design environment through a graphical user interface (GUI) generating one or more aspects of the system described herein. In some embodiments, data models include one or more entity attribute categories which may include one or more entity compatibility attributes. For example, a 2″ connector will only work on a 2″ cable, so a data model for a 2″ cable will have a requirement for a 2″ connectors as a compatibility attribute, while a data model for a 2″ connector with have a 2″ cable requirement. In some embodiments, data models are configured to be modified by a user, where a plurality of data models are stored in a library. In some embodiments, the system is configured to determine and/or display which entities are compatible with each other based on one or more data models.

In some embodiments, as used herein, a name and/or icon representing a data model is referred to as a vocabulary, where the system is configured to enable a user to assign one or more vocabularies to entity in a conceptual model in the runtime environment. In some embodiments, the entity vocabulary controls whether or not a connection is allowed, and/or what compatibility entities are automatically generated by the system to enable connection between two entity types with non-compatible vocabulary. A non-limiting example implementation may include dragging a vocabulary representation from a vocabulary library to an entity in the runtime environment to create the assignment. Using the system and methods described herein, each entity in the design environment can “speak” to each other using the vocabulary to determine if they are compatible.

In some embodiments, the system is configured to enable a user to define the domain in which the modeling occurs (e.g., instrumentation, mechanical, and/or electrical domain). In some embodiments, defining the domain is configured to generate a domain specific library. In some embodiments, each library may include entities and/or vocabularies. In some embodiments, selection of a vocabulary item is configured to generate a data model window with one or more editable field for assigning attributes and/or links. In some embodiments, the system is configured to interface modeling software design environment logic (i.e., programming) using a model vocabulary script to associate domain specific functions/features when model components are created and/or connected on a modeling canvas. In some embodiments, vocabulary in one or more vocabulary scripts cater to various engineering domain specific functions (e.g., specific connector types between electrical components), thus allowing the user to have flexibility in modeling by automatically populating required interface parts while at the same time providing the model a structure that is required for fulfilling domain functions.

In some embodiments, by defining a vocabulary for generic entities, the system is configured to limit a conceptual model to the requirements of a given domain. For example, a coupling may have a different meaning in an electrical domain vs. a mechanical domain. In some embodiments, the system is configured decorate (the terms decorate and assign may be used interchangeably herein) entities in the design environment canvas with domain specific nouns (e.g., tension cable, communication cable) using the vocabulary to eliminate ambiguity for items that may have multiple meanings or are specific to a particular project/environment. In some embodiments, when design environment logic needs to perform domain related operations, then it queries the assigned data model by using the vocabulary decorations for the operation thus knowing which other entities are required to perform the connection between entities. In some embodiments, the system enables developers to define multiple vocabularies for different domains (e.g., Process, Electrical and Instrumentation etc.) by providing a generic template for generic entities enabling an end user (e.g., project administrator) to assign different meanings in different projects using the vocabulary. In some embodiments, similar generic entities decorated with domain specific vocabulary in a same conceptual model allows for multiple engineering domain functionalities preventing connection of the generic entities from different domains that do not share a link through common vocabulary.

In some embodiments, the domain specific vocabulary is devolved with the help of domain experts. In some embodiments, at least some of the vocabulary is shipped with the software modeling product supplied by a vender (e.g., AVEVA®). In some embodiments, the system is configured to enable an end user of the product to define one or more required component attributes in a data model for a conceptual model. In some embodiments, one or more conceptual model entities are limited by the structure of the vocabulary upon enabling of the vocabulary. In some embodiments, the system is configured to enable a user to start with generic entities for a conceptual model and enable assignment of the vocabulary to the entities at any time to create specific entities. In some embodiments, the system is configured to automatically generate and/or list the necessary compatible entities in the design environment which can then be used to link the specific entities per a project's vocabulary requirements.

In some embodiments, the system comprises one or more computers comprising one or more processors and one or more non-transitory computer readable media. In some embodiments, the one or more non-transitory computer readable media include program instructions stored thereon that when executed cause the one or more computers to execute one or more steps. Some embodiments includes a step to generate, by the one or more processors, a design environment. In some embodiments, the design environment is configured to enable a user to create a model of an industrial process using one or more entities. Some embodiments includes a step to generate, by the one or more processors, an entity library comprising one or more generic entities. In some embodiments, the one or more generic entities each comprise a visual representation of a generic attribute associated with the industrial process. Some embodiments includes a step to generate, by the one or more processors. In some embodiments, a vocabulary library comprises one or more vocabulary items. In some embodiments, the one or more vocabulary items each comprise a visual representation of a data mode. Some embodiments includes a step to execute, by the one or more processors, an association between the one or more vocabulary items and the one or more generic entities in the design environment to create specific entities.

In some embodiments, each data model comprises one or more attributes. In some embodiments, the design environment is configured to compare one or more attributes between specific entities when a link between the specific entities is attempted in the design environment. In some embodiments, the data model is configured to be edited by the user. In some embodiments, editing the data model includes adding the one or more attributes to the data model.

In some embodiments, the design environment is configured to prevent a link between specific entities that do not share the one or more attributes. In some embodiments, the design environment is configured to prevent a link between specific entities and generic entities. In some embodiments, the design environment is configured to automatically assign one or more vocabulary items to a generic entity when a link between a specific entity and the generic entity is attempted. In some embodiments, the design environment is configured to enable links between a first generic entity and a second generic entity.

In some embodiments, the one or more non-transitory computer readable media further include program instructions stored thereon that when executed cause the one or more computers to execute, by the one or more processors, an association of one or more vocabulary items to the second generic entity automatically when at least one vocabulary item is associated with the first generic entity. In some embodiments, a visual representation of a generic entity includes a generic entity icon. In some embodiments, a visual representation of a vocabulary item includes a vocabulary item icon.

Some embodiments includes a step to execute, by the one or more processors, a visual representation of a specific entity in the design environment. In some embodiments, the visual representation of the specific entity includes an overlay of the vocabulary item icon on the generic entity icon in the design environment. In some embodiments, attributes include one or more details about one or more of a component, a signal, a schematic, and/or a process associated with the industrial process.

In some embodiments, the system is configured to enable a user to execute a name change for a specific entity. In some embodiments, the system is configured to propagate the name change to other specific entities that share one or more same vocabulary items. In some embodiments, the system is configured to limit a display of generic entities in the entity library and/or vocabulary items in the vocabulary library to a particular domain.

### DETAILED DESCRIPTION OF THE DRAWINGS

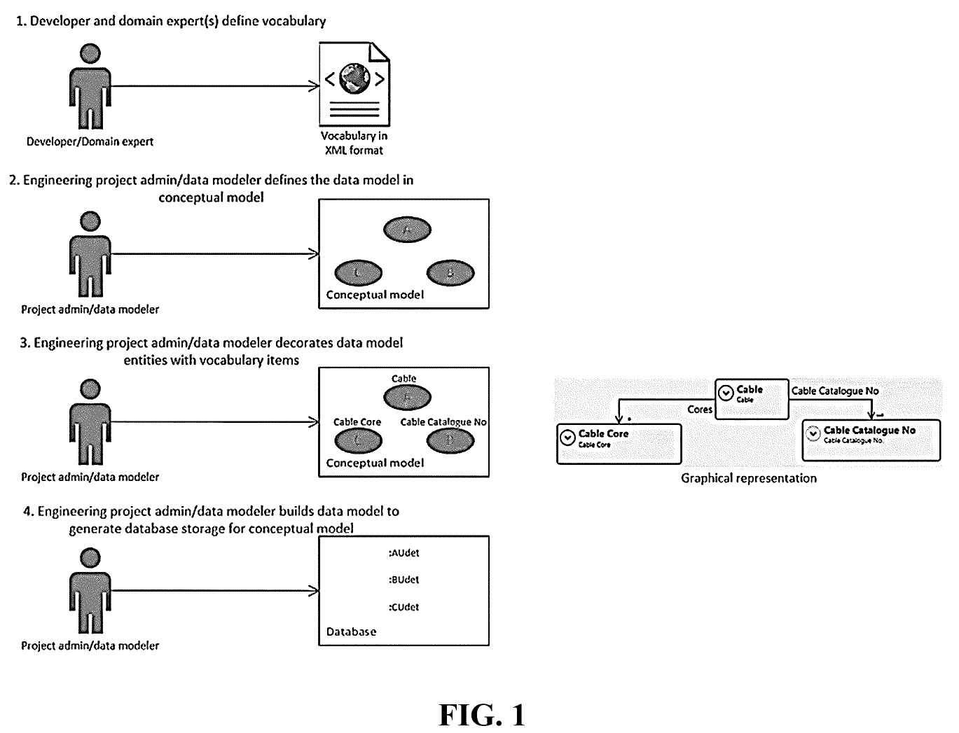

FIG. 1 illustrates general functionality employed by the system according to some embodiments.

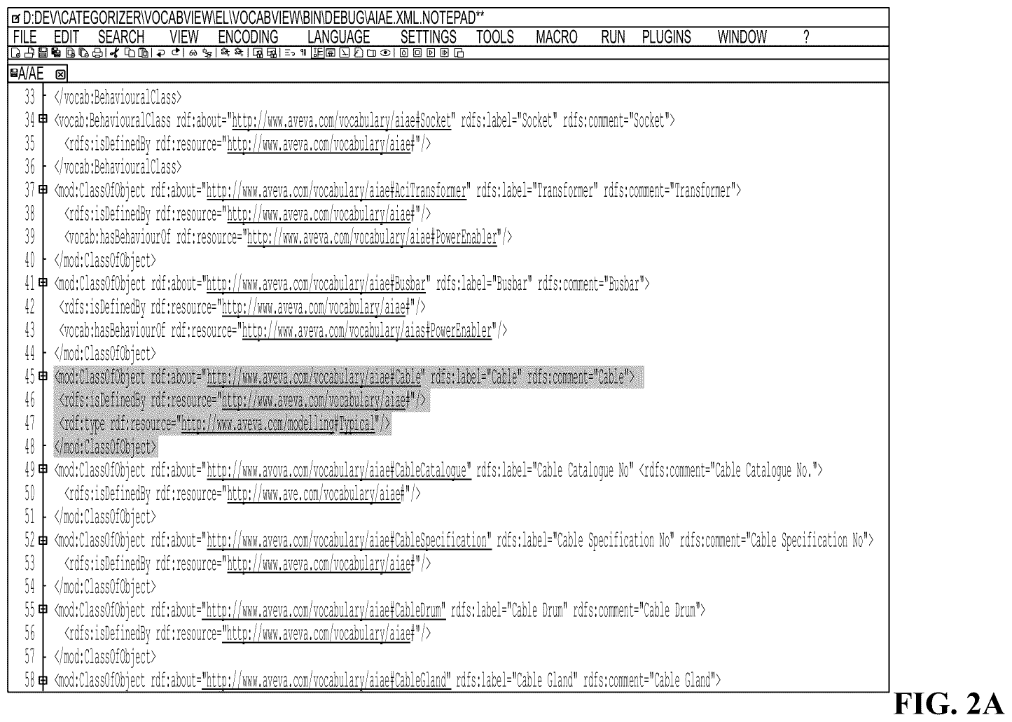

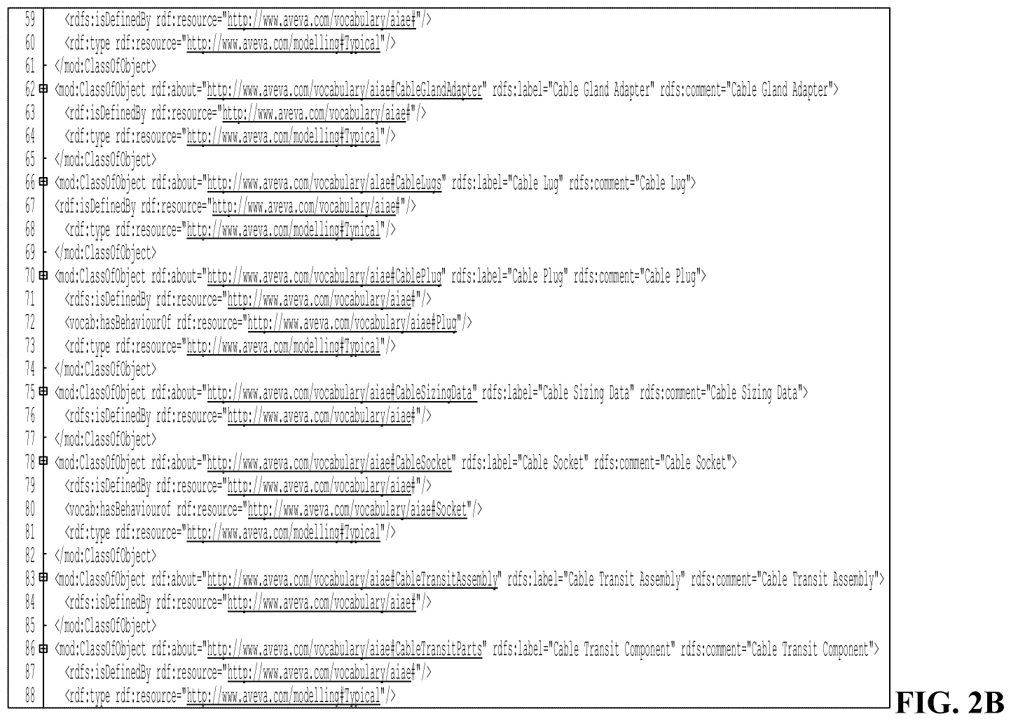

FIGS. 2A-B show the vocabulary created and/or stored in an XML format, as a non-limiting example according to some embodiments.

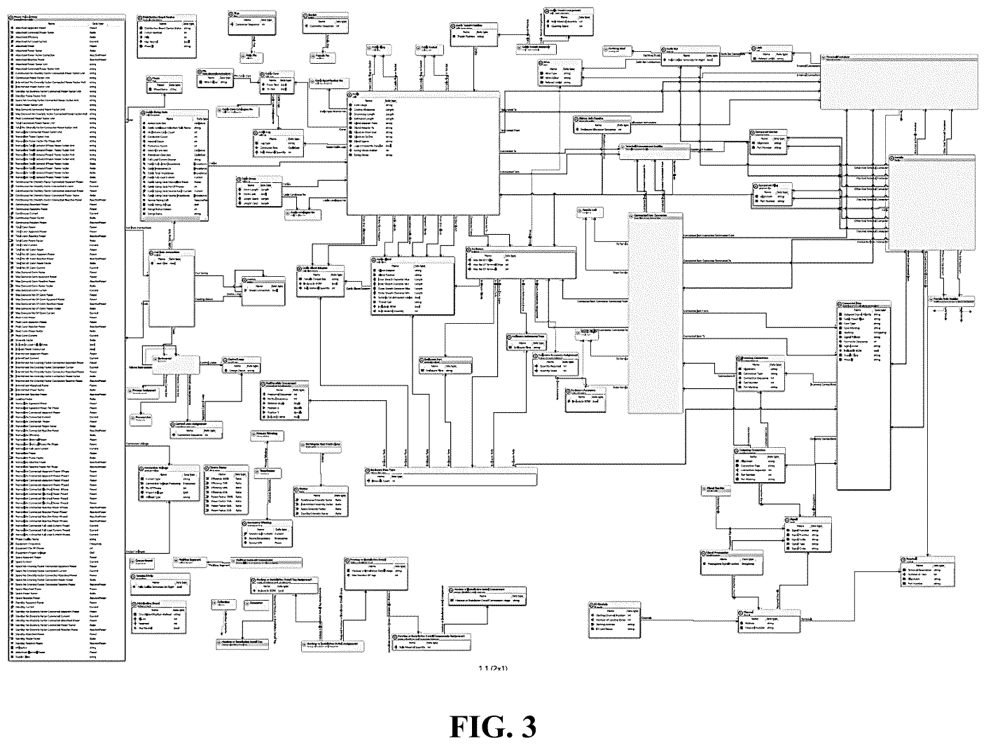

FIG. 3 depicts an XML viewer graphical rendering of the XML text in FIG. 2 according to some embodiments.

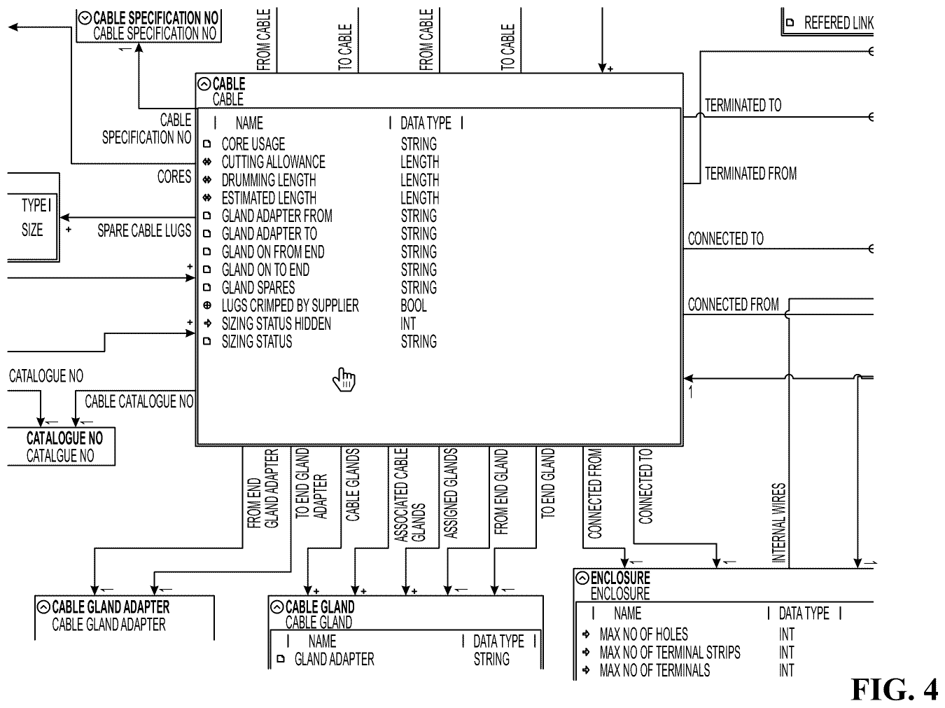

FIG. 4 is a zoomed view on the cable portion of the graphical rendering of FIG. 3 according to some embodiments.

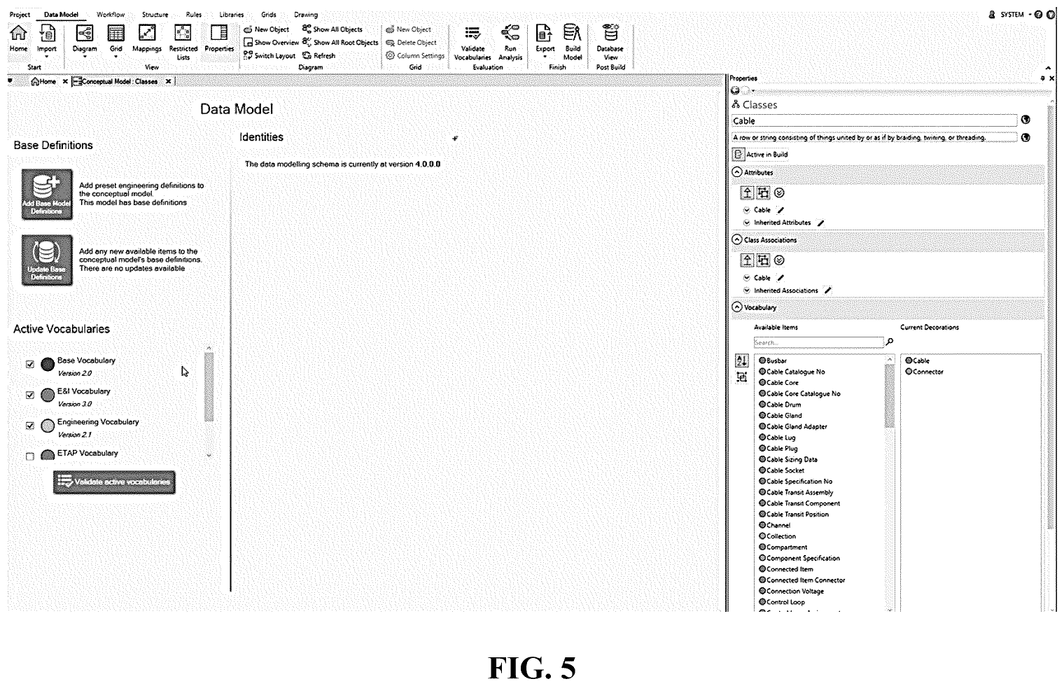

FIG. 5 illustrates a second step being implemented in a design environment on a GUI according to some embodiments.

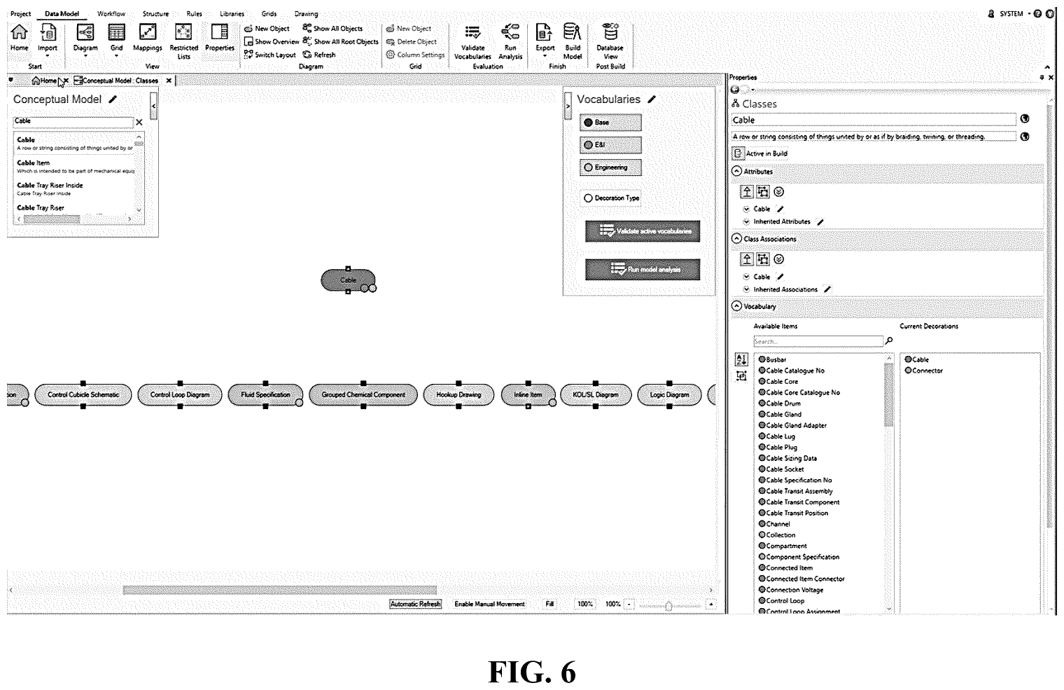

FIG. 6 shows a display comprising a GUI that includes the conceptual design environment according to some embodiments.

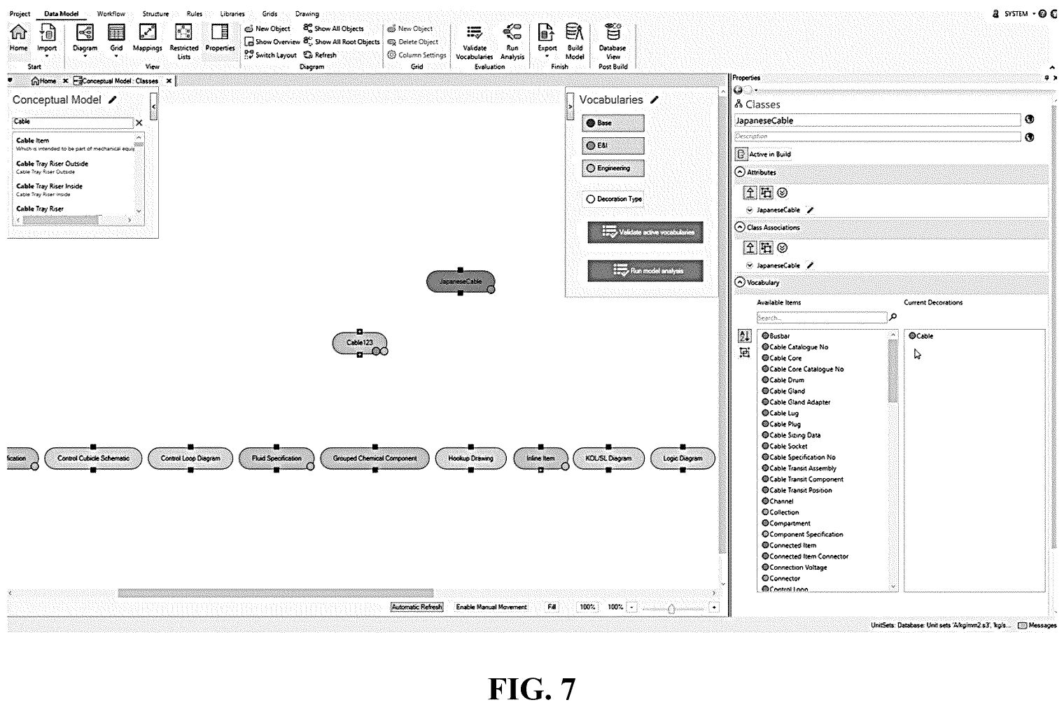

FIG. 7 depicts a scenario where the name of the decorated cable entity has been changed and a new generic cable entity has been added according to some embodiments.

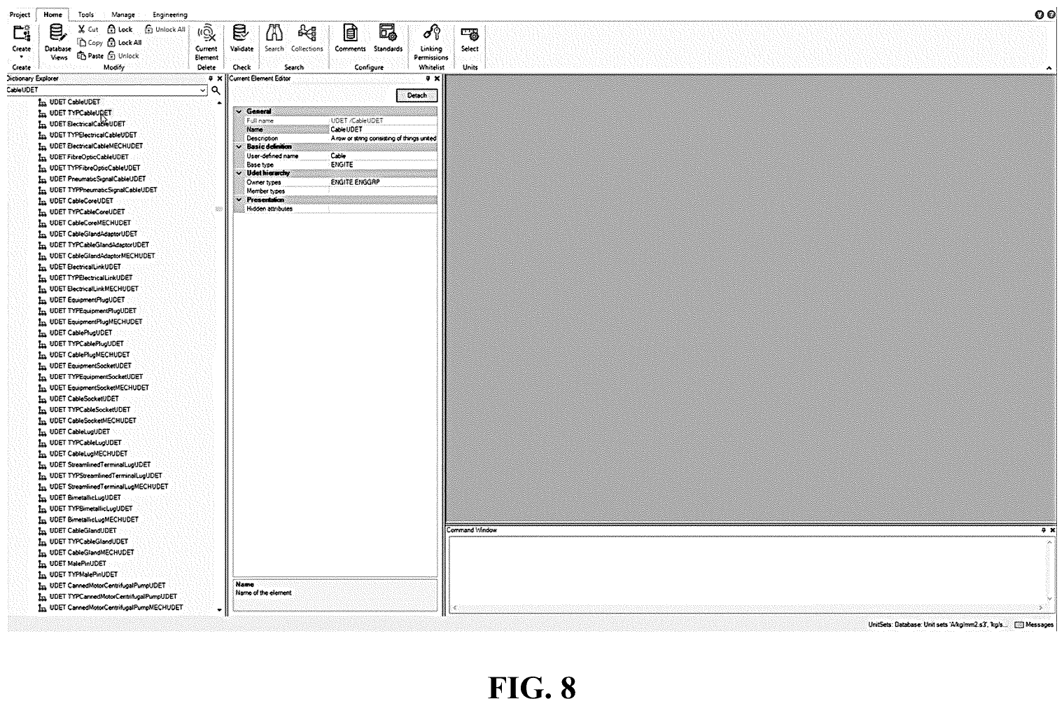

FIG. 8 shows the storage model generated by the system after vocabulary validation according to some embodiments.

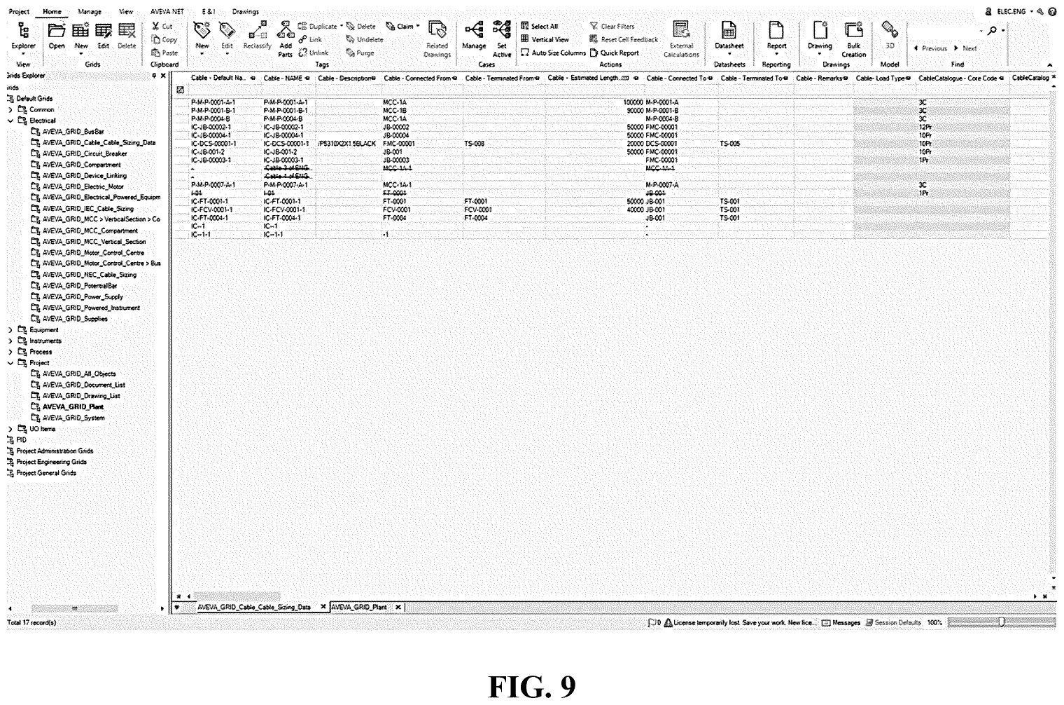

FIG. 9 depicts an engineering environment portion of the system according to some embodiments.

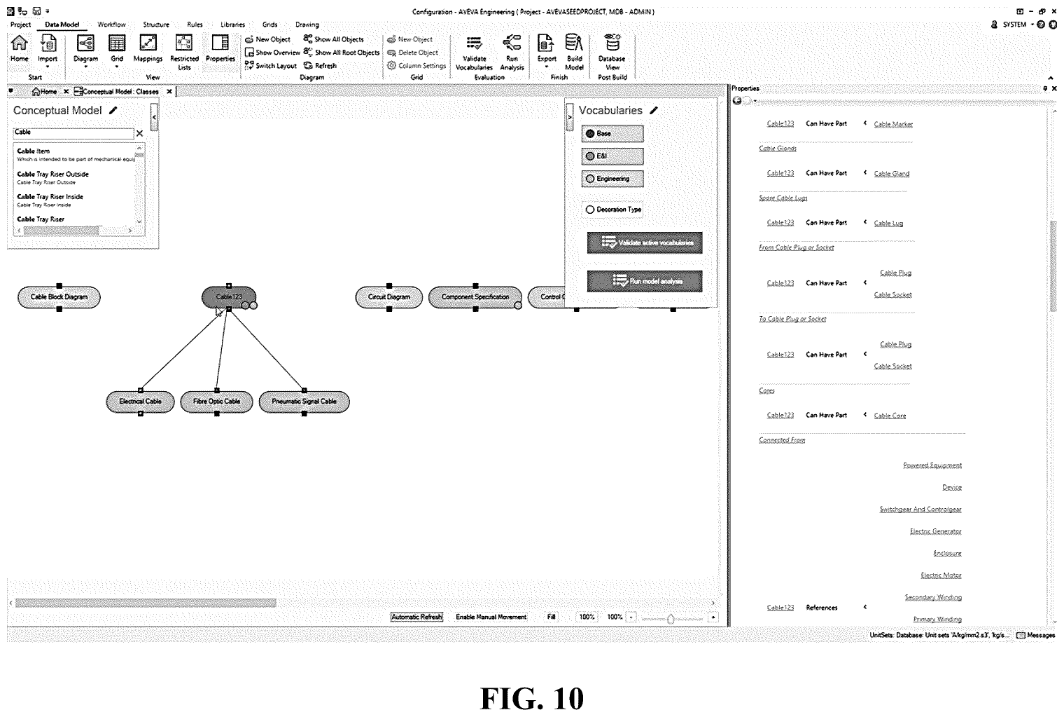

FIG. 10 illustrates the expansion of a class in the conceptual environment to display subclasses according to some embodiments.

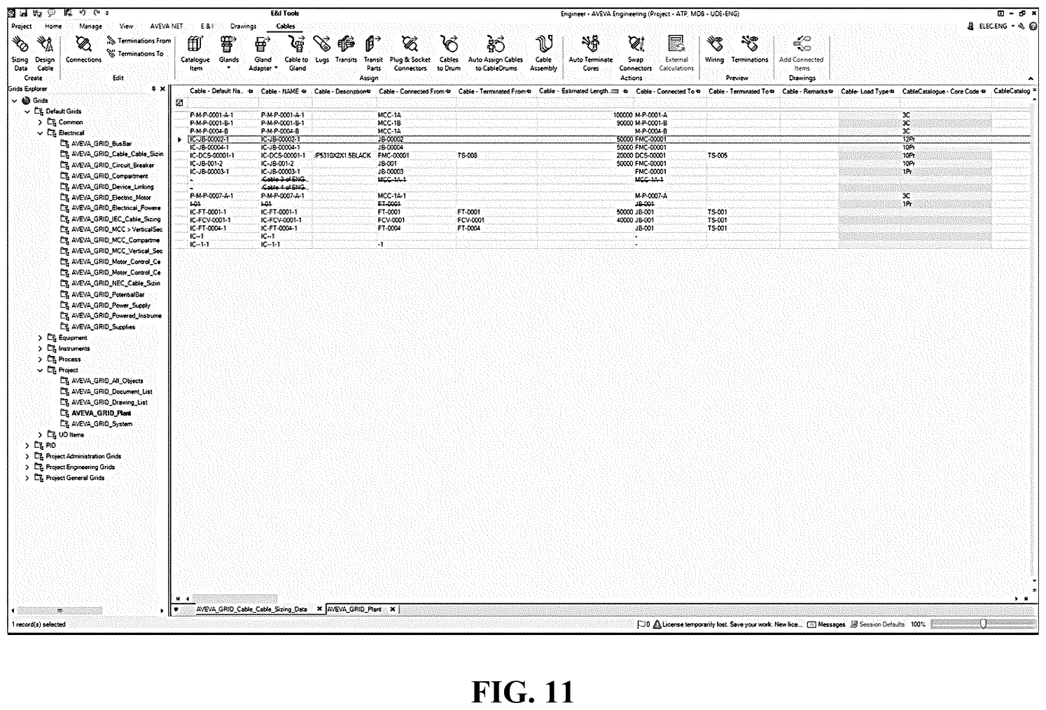

FIG. 11 illustrates the system generating a new tab when a specific cable from the engineering environment is selected according to some embodiments.

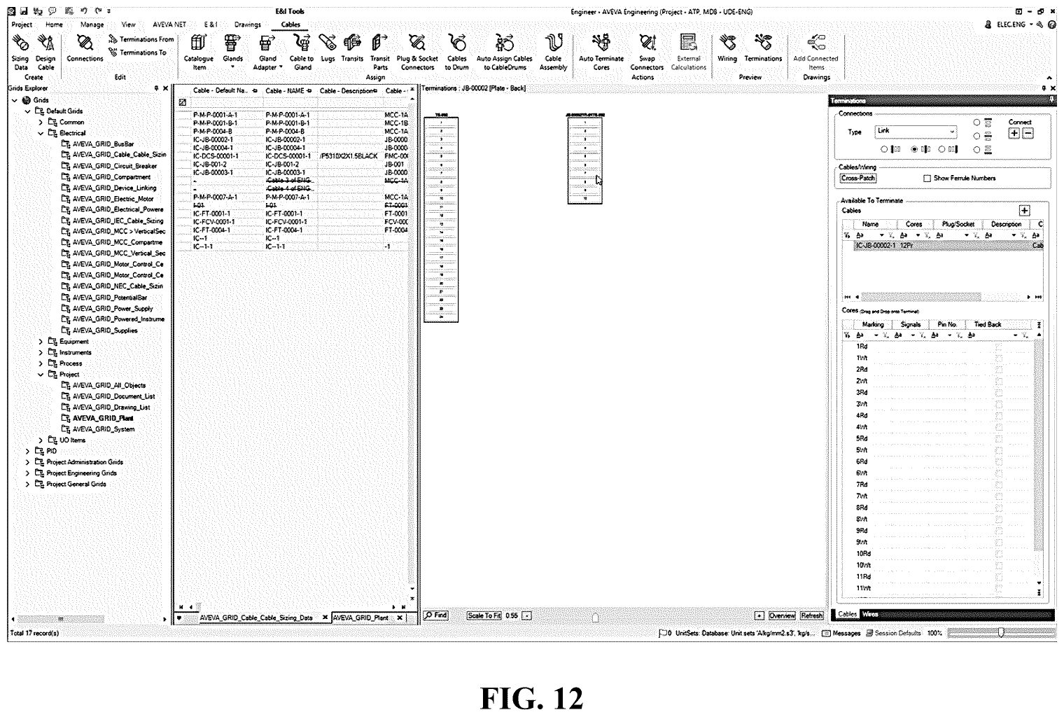

FIG. 12 depicts a GUI displaying the terminations editor according to some embodiments.

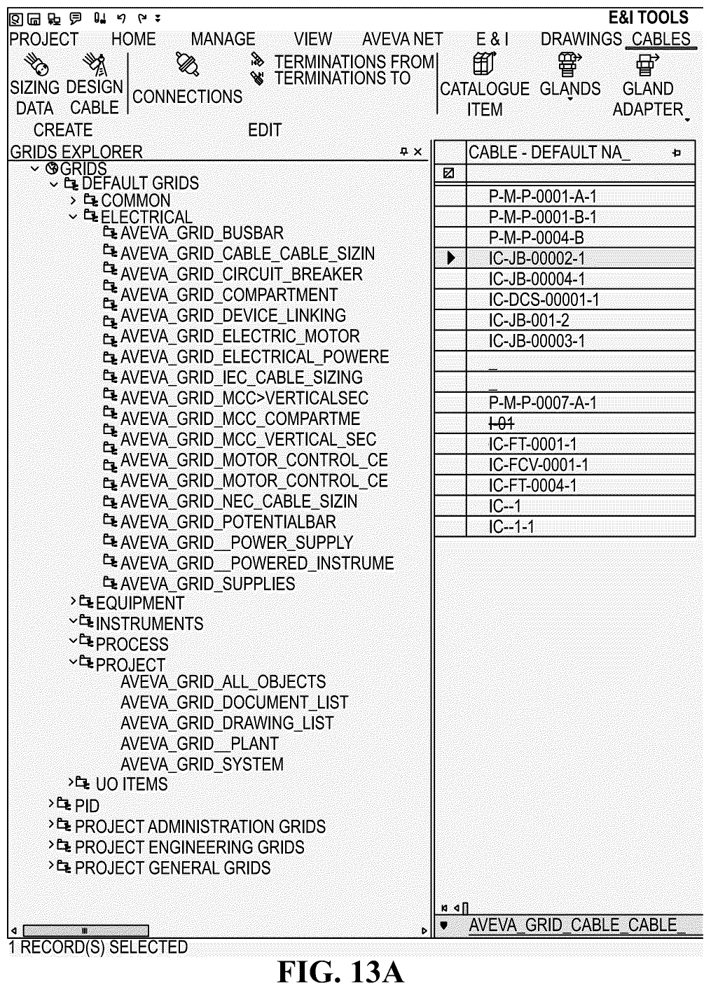

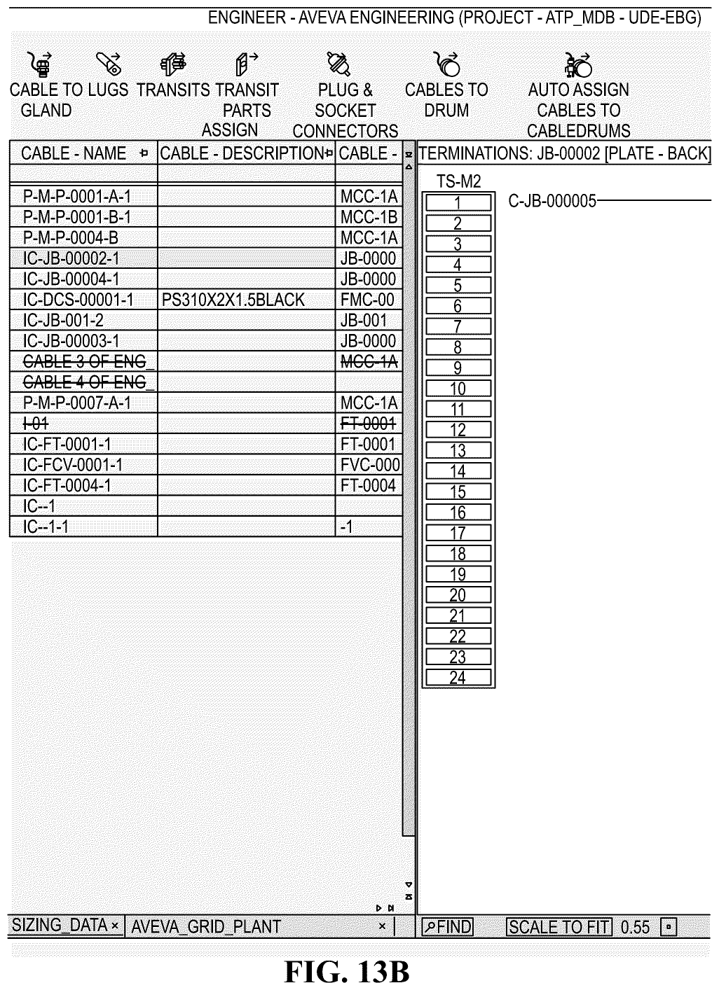

FIGS. 13A-D show the 1Rd from the Cores Window in FIG. 12 being terminated onto a terminal in the junction box according to some embodiments.

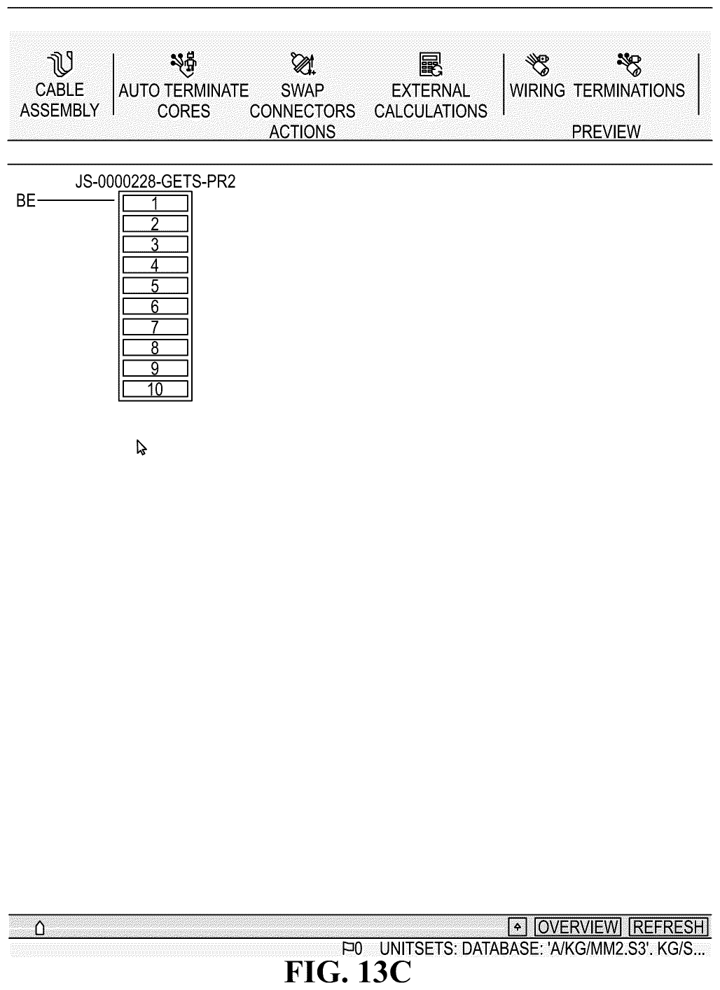

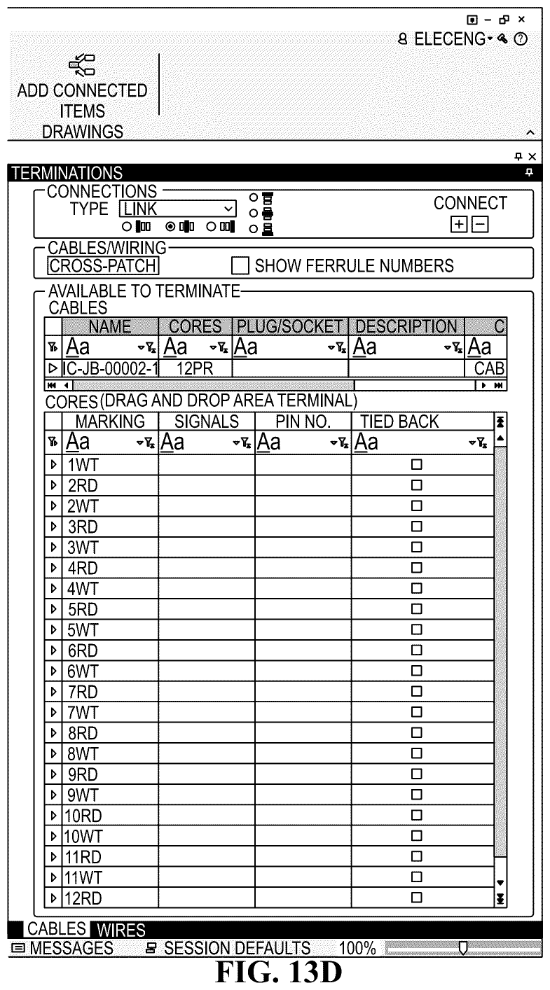

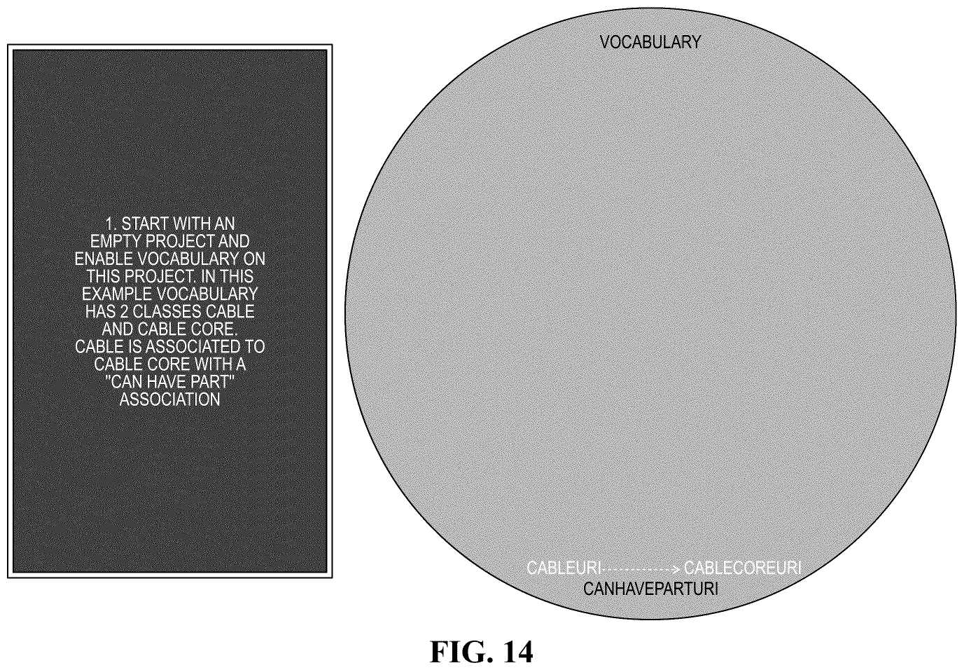

FIG. 14 illustrates a first step of a method for implementing the system according to some embodiments.

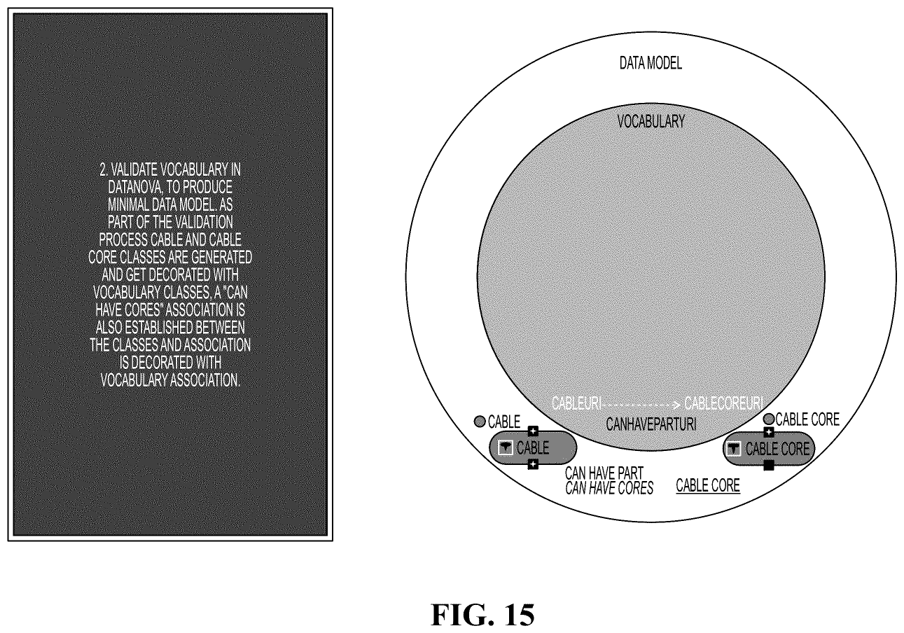

FIG. 15 illustrates a second step of a method for implementing the system according to some embodiments.

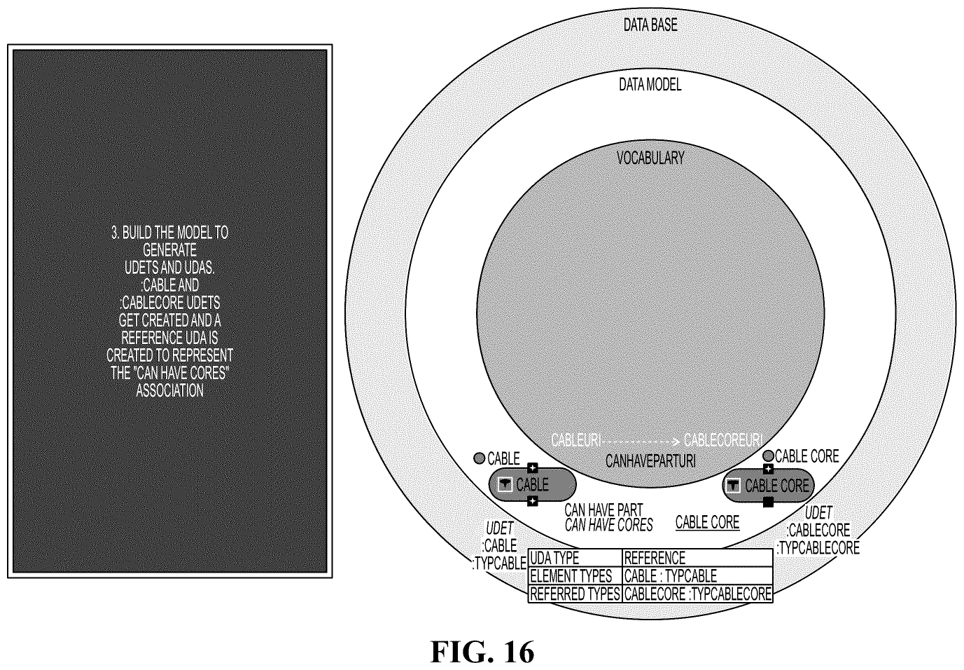

FIG. 16 shows a third step of a method for implementing the system according to some embodiments.

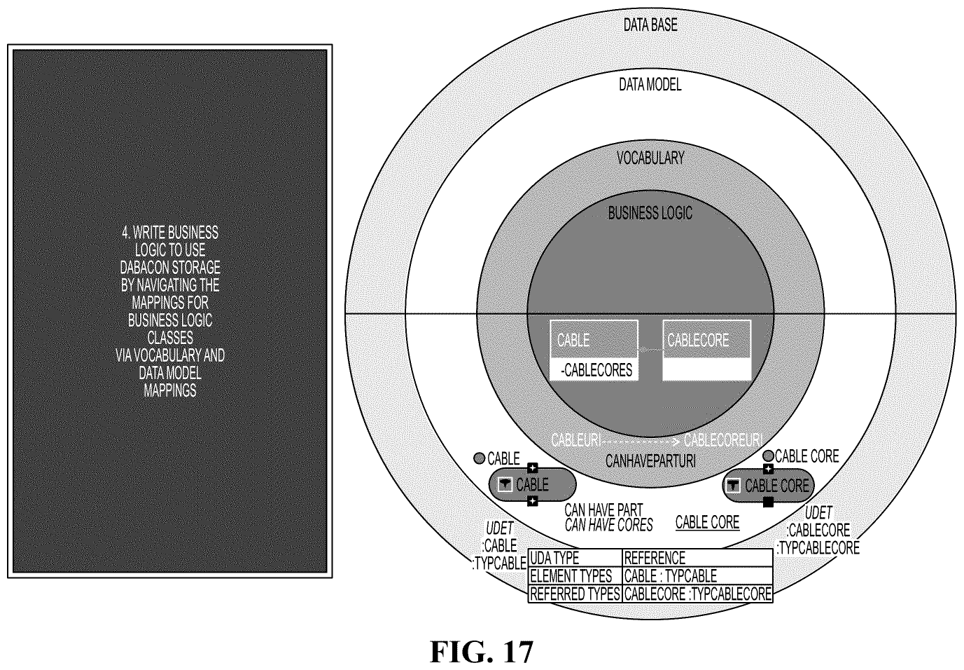

FIG. 17 depicts a fourth step of a method for implementing the system according to some embodiments.

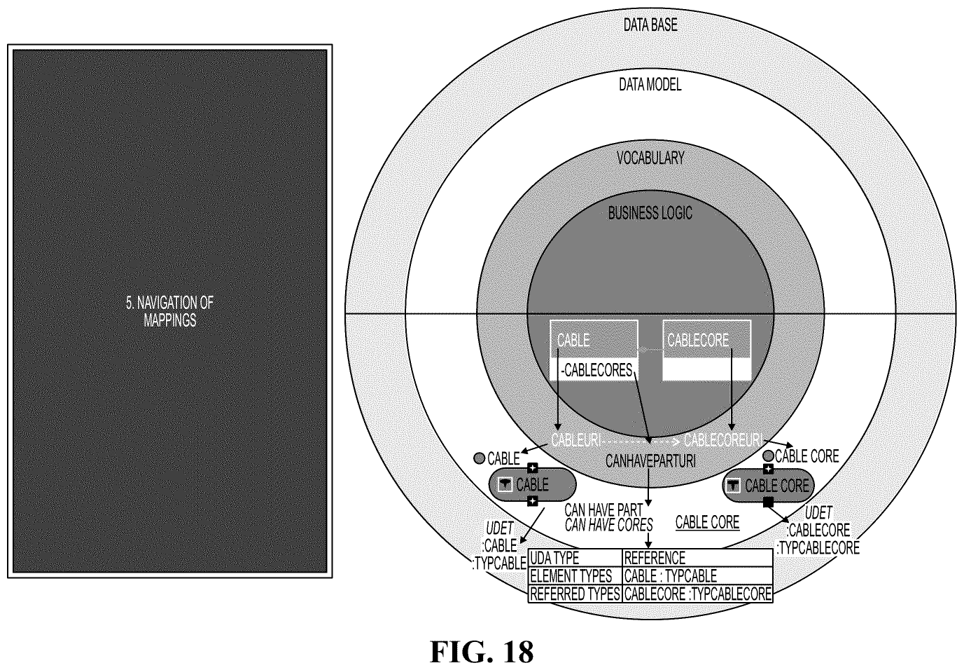

FIG. 18 depicts a fifth step of a method for implementing the system according to some embodiments.

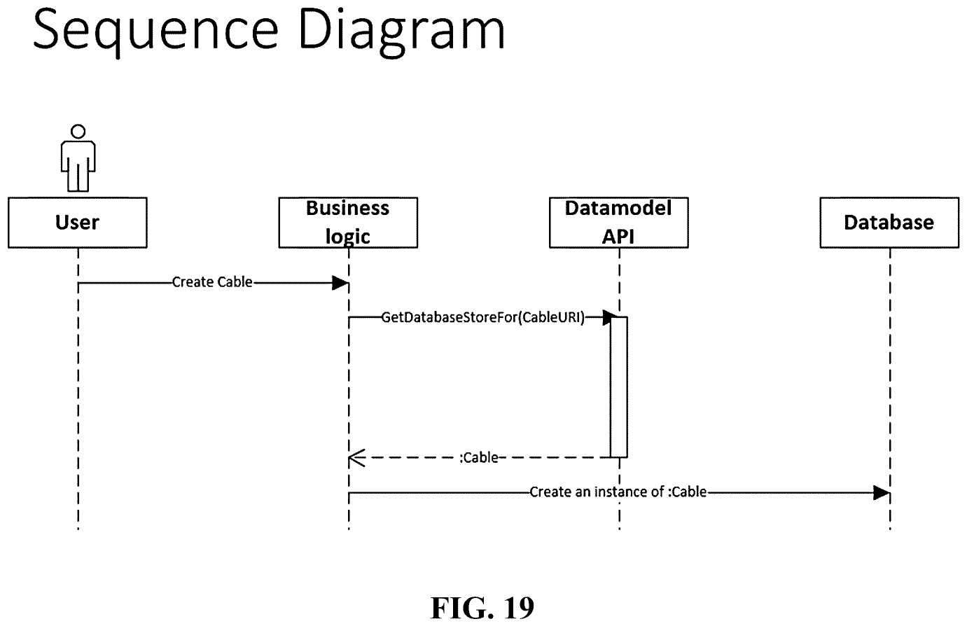

FIG. 19 shows a sequence diagram for implementing the system on a cable class according to some embodiments.

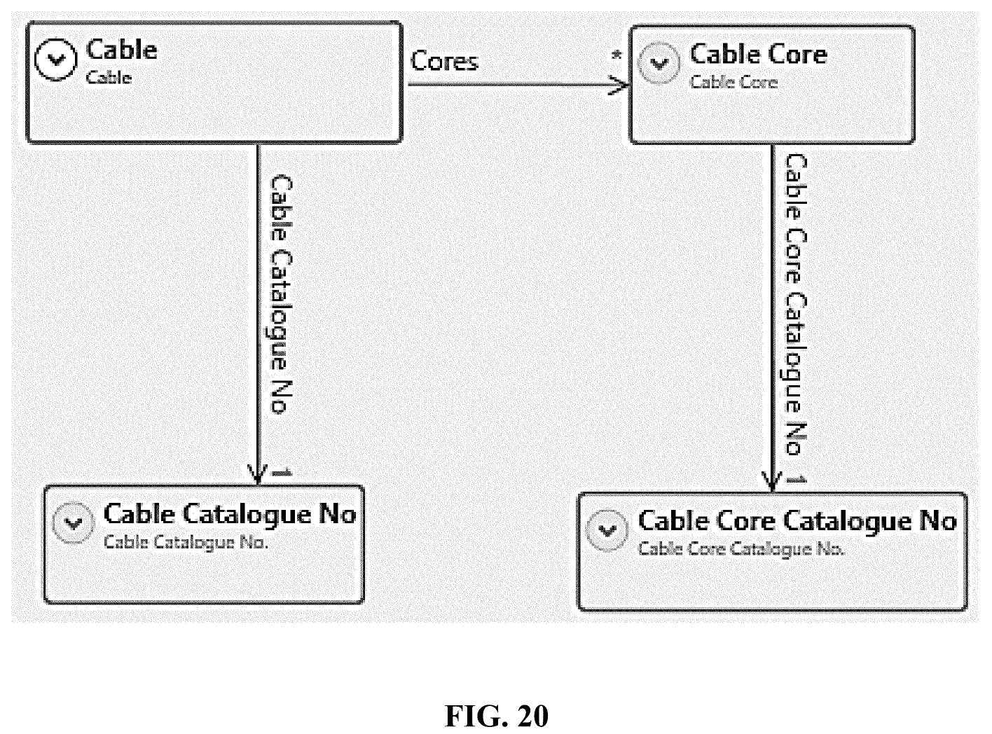

FIG. 20 illustrates a non-limiting example vocabulary for an engineering and instrumentation (E&I) class according to some embodiments.

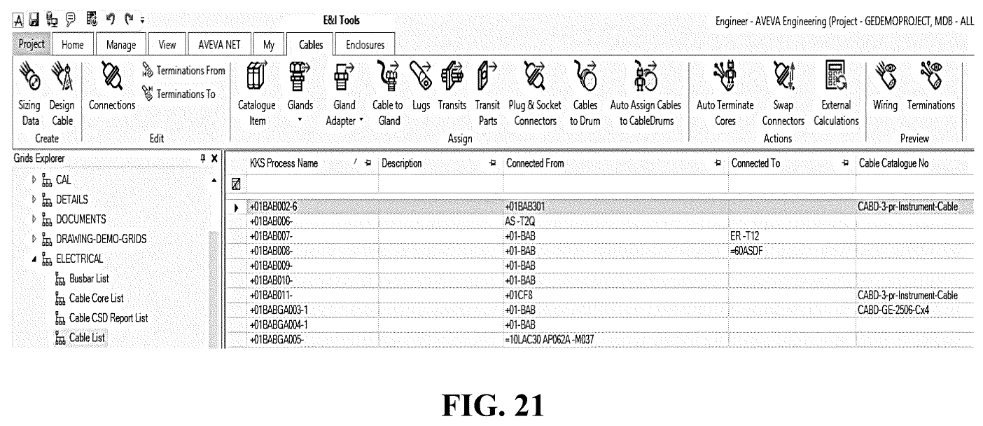

FIG. 21 shows the addition of a Cables ribbon when an element of type “cable” is selected according to some embodiments.

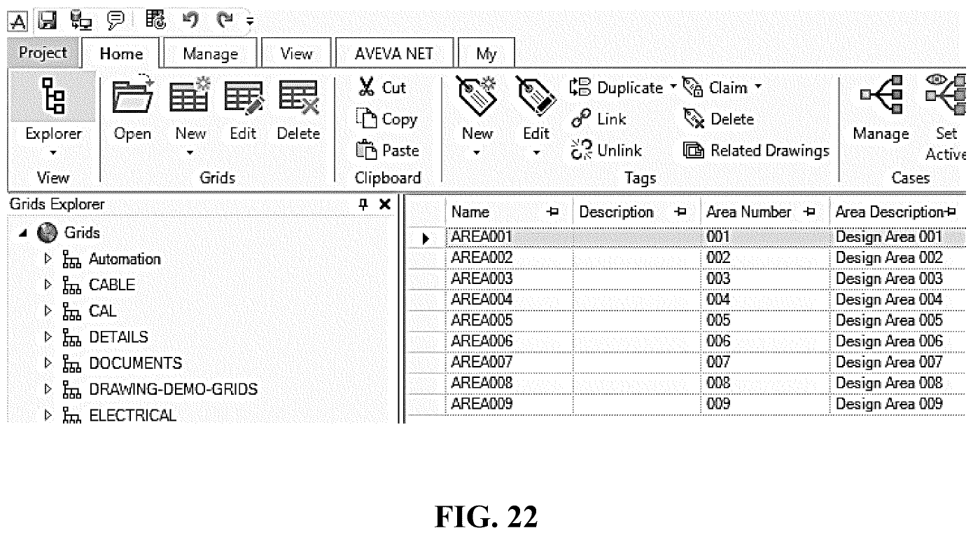

FIG. 22 shows removal of a Cables ribbon when an element other than a type “cable” is selected according to some embodiments.

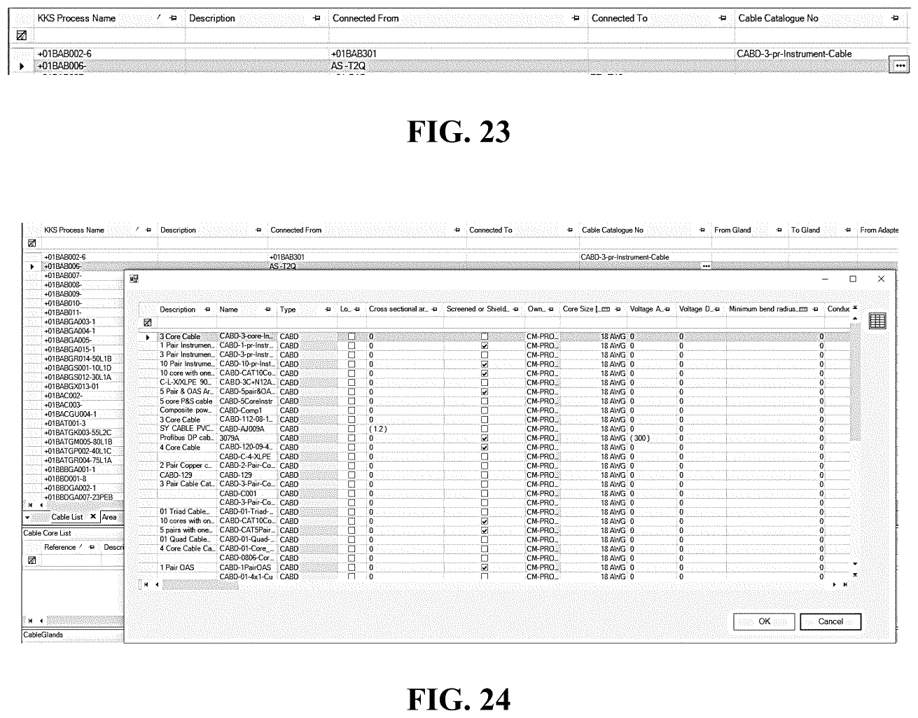

FIG. 23 depicts a “Cable Catalog No” reference number selection button according to some embodiments.

FIG. 24 shows the Cable Catalog reference browser according to some embodiments.

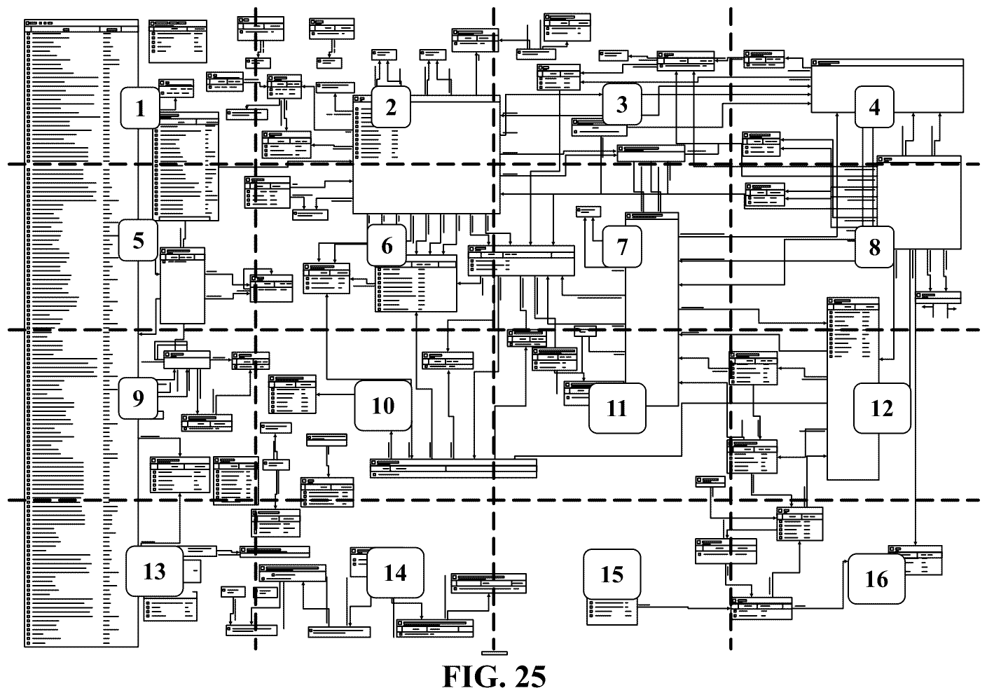

FIG. 25 illustrates the non-limiting example cable vocabulary map sectioned into a grid according to some embodiments.

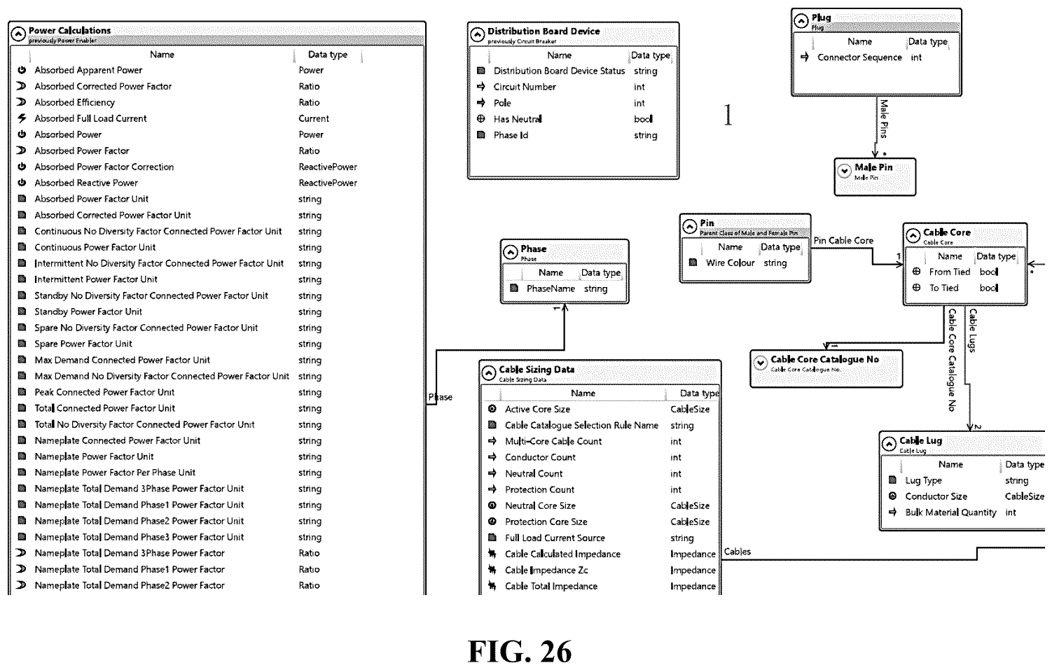

FIG. 26 shows section 1 of the vocabulary grid of FIG. 25 according to some embodiments.

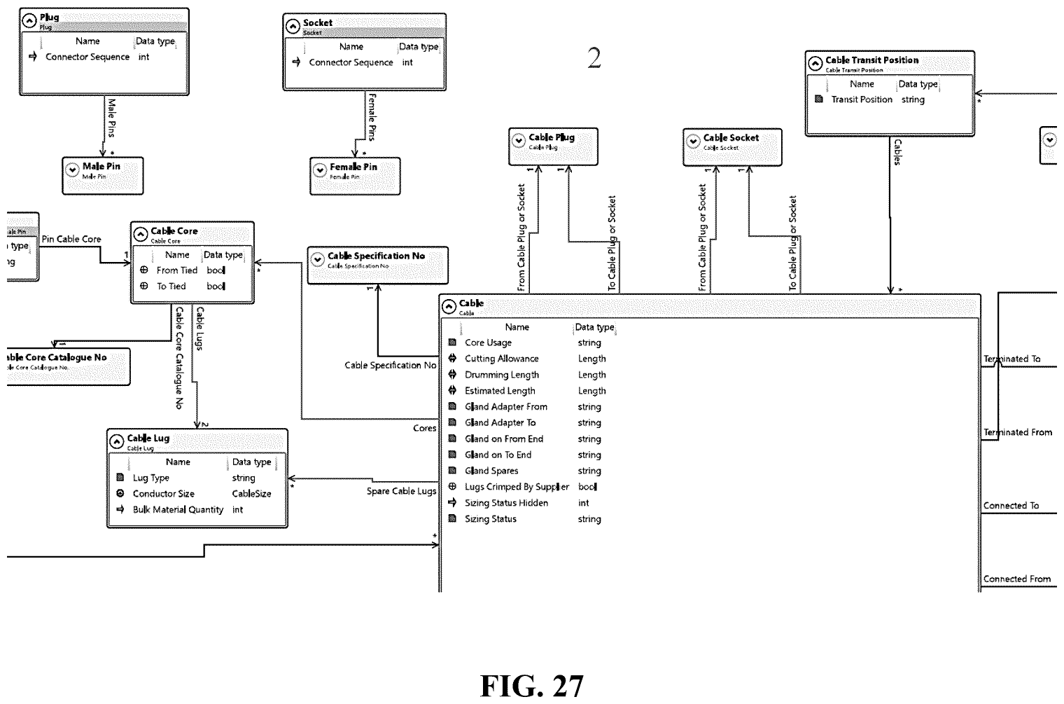

FIG. 27 depicts section 2 of the vocabulary grid of FIG. 25 according to some embodiments.

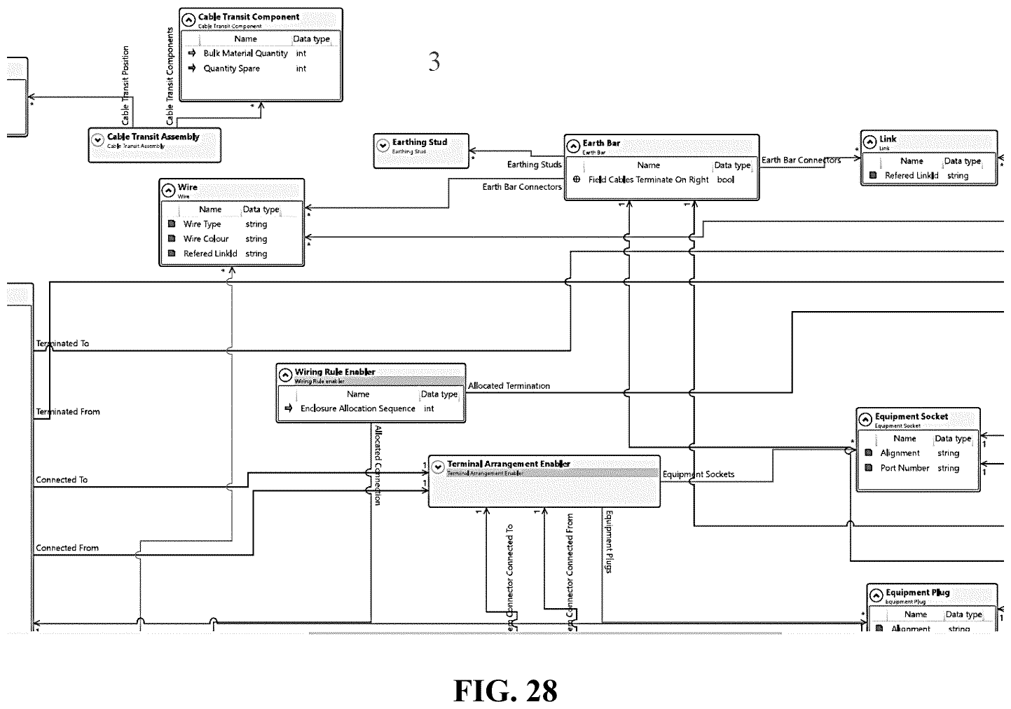

FIG. 28 shows section 3 of the vocabulary grid of FIG. 25 according to some embodiments.

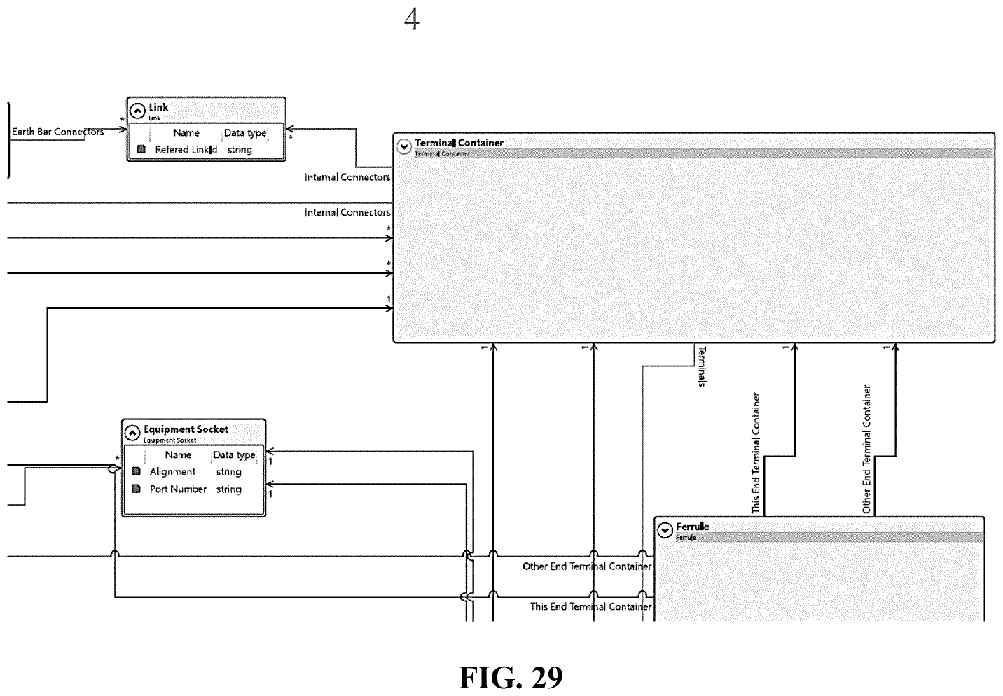

FIG. 29 illustrates section 4 of the vocabulary grid of FIG. 25 according to some embodiments.

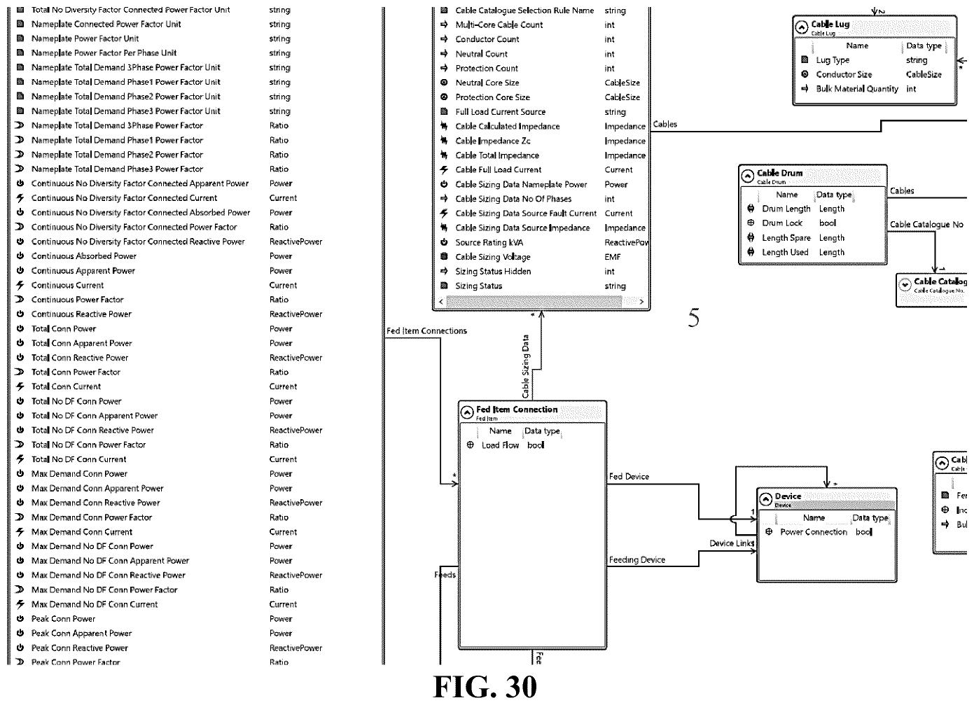

FIG. 30 depicts section 5 of the vocabulary grid of FIG. 25 according to some embodiments.

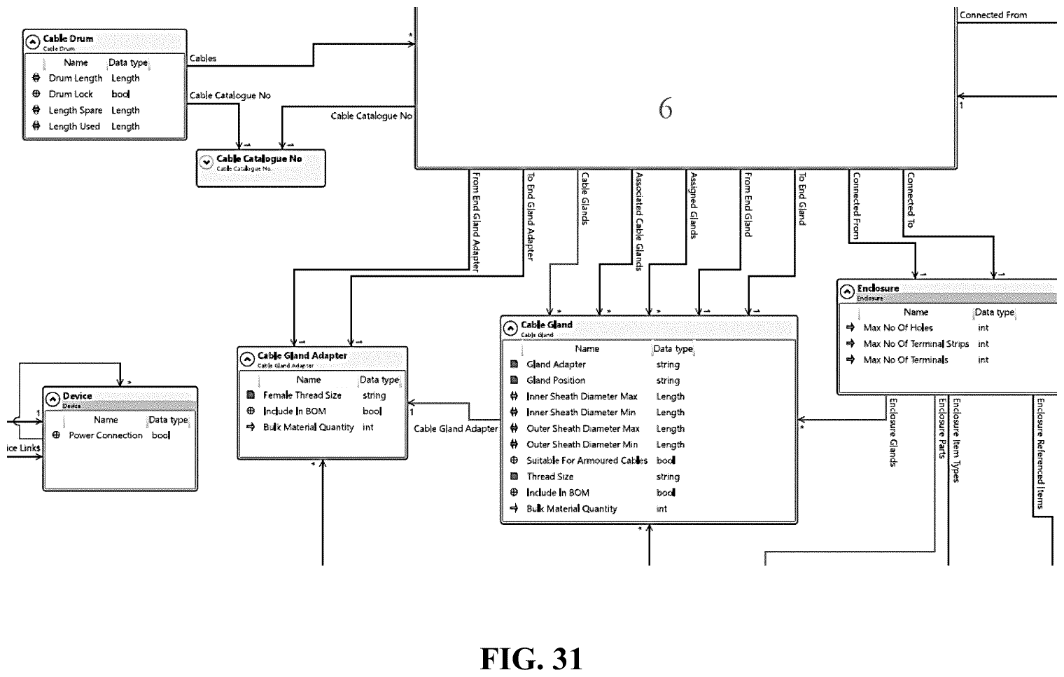

FIG. 31 depicts section 6 of the vocabulary grid of FIG. 25 according to some embodiments.

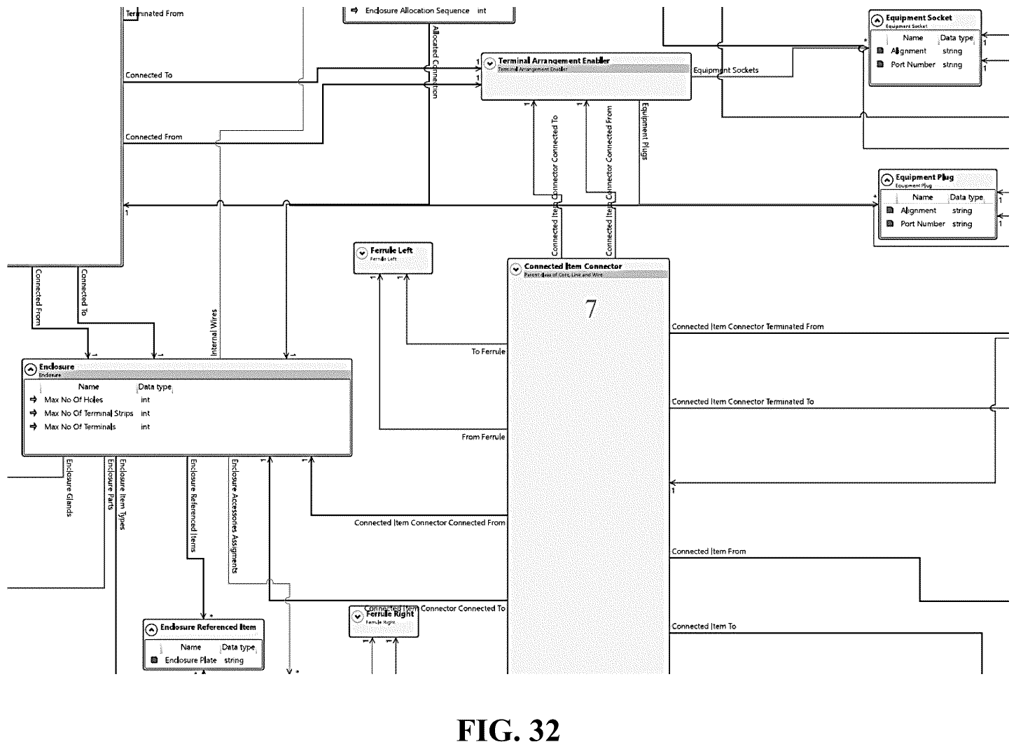

FIG. 32 shows section 7 of the vocabulary grid of FIG. 25 according to some embodiments.

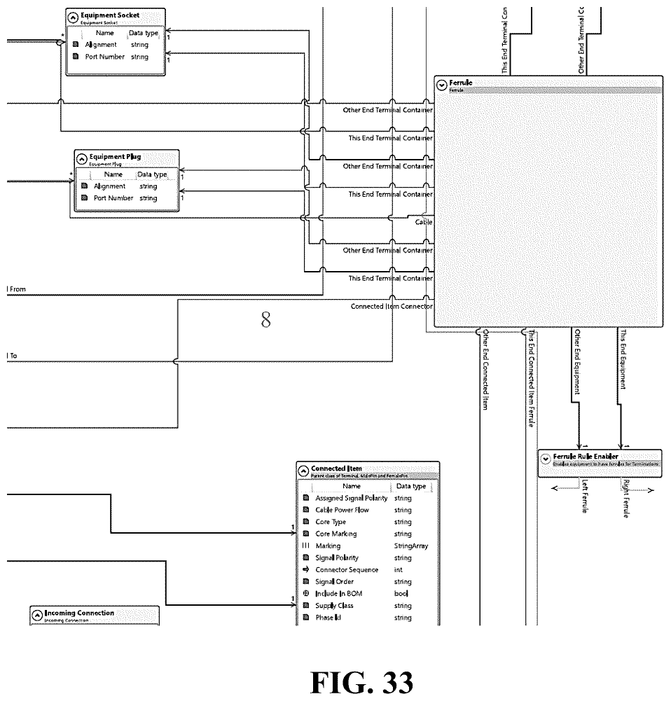

FIG. 33 illustrates section 8 of the vocabulary grid of FIG. 25 according to some embodiments.

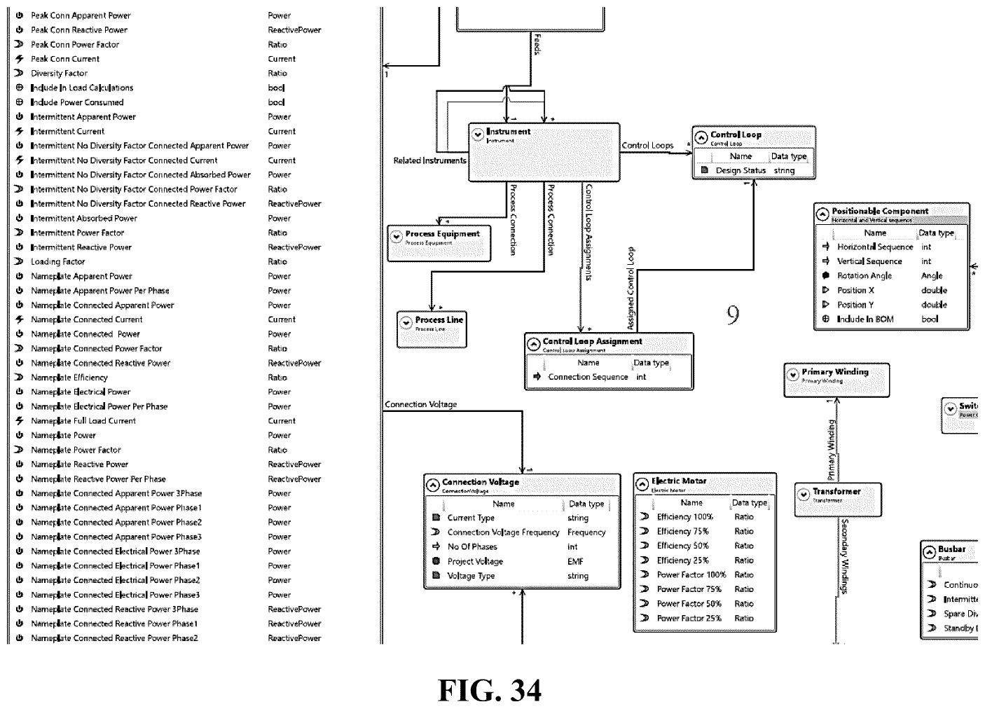

FIG. 34 illustrates section 9 of the vocabulary grid of FIG. 25 according to some embodiments.

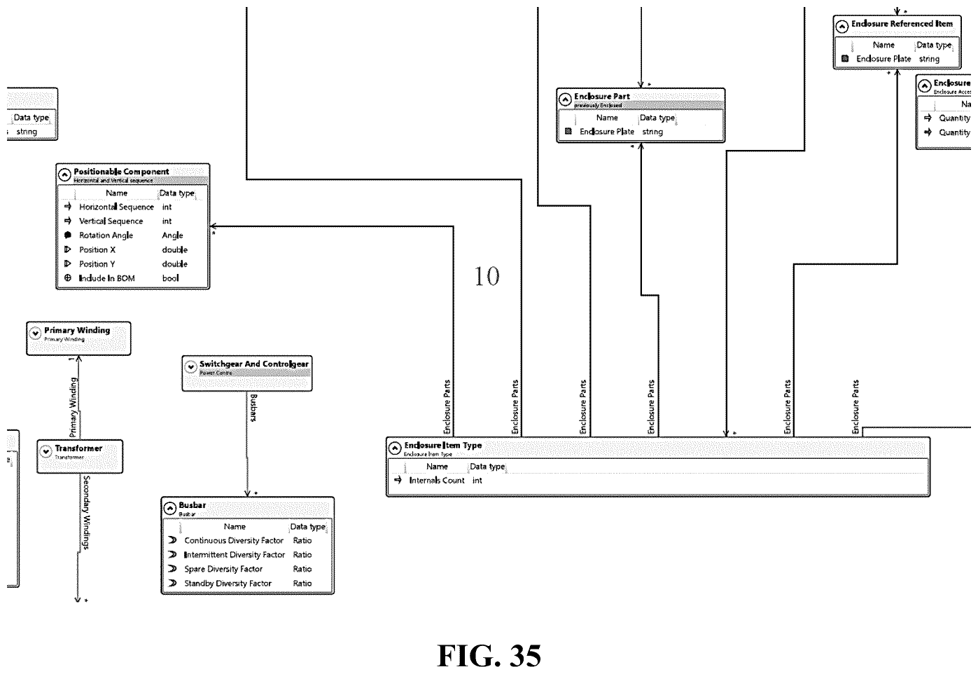

FIG. 35 shows section 10 of the vocabulary grid of FIG. 25 according to some embodiments.

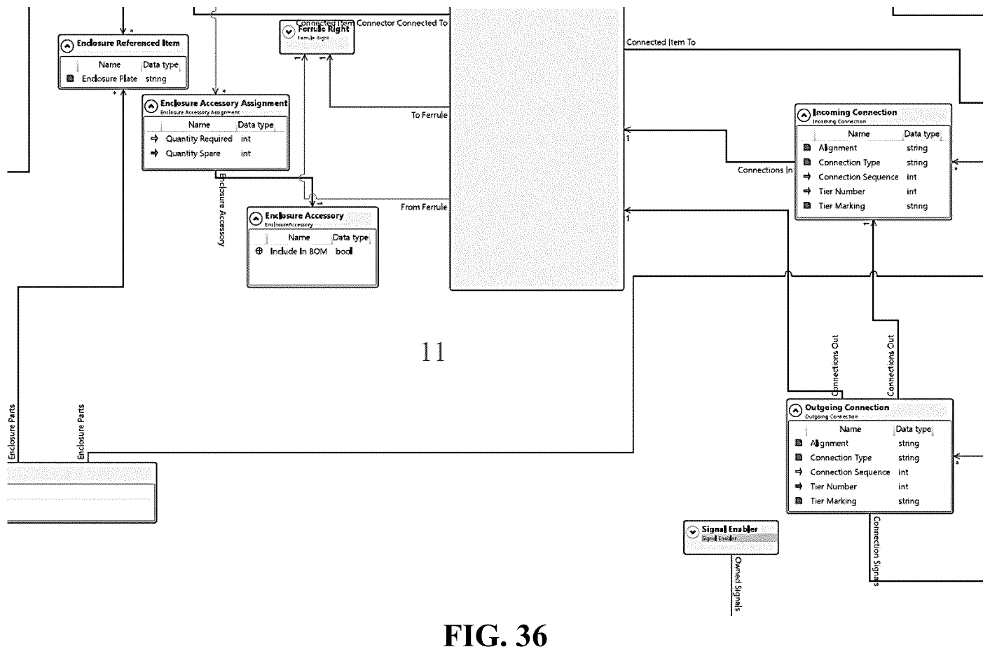

FIG. 36 depicts section 11 of the vocabulary grid of FIG. 25 according to some embodiments.

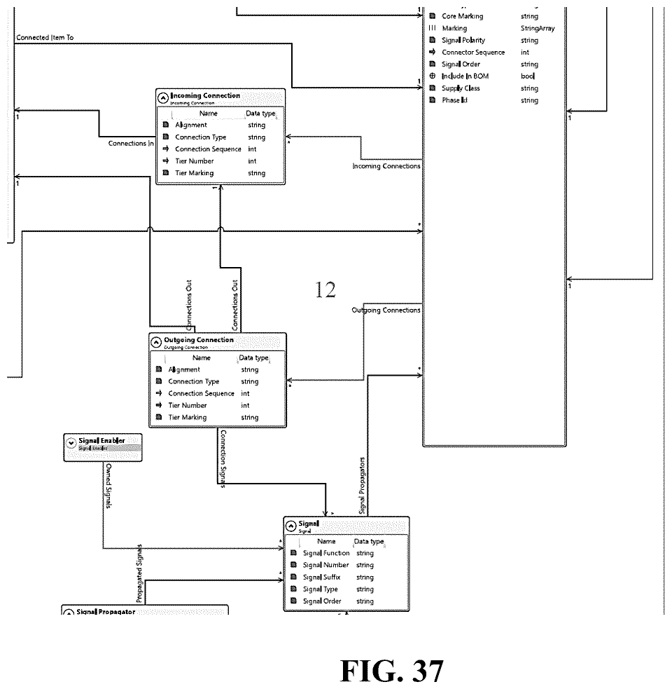

FIG. 37 shows section 12 of the vocabulary grid of FIG. 25 according to some embodiments.

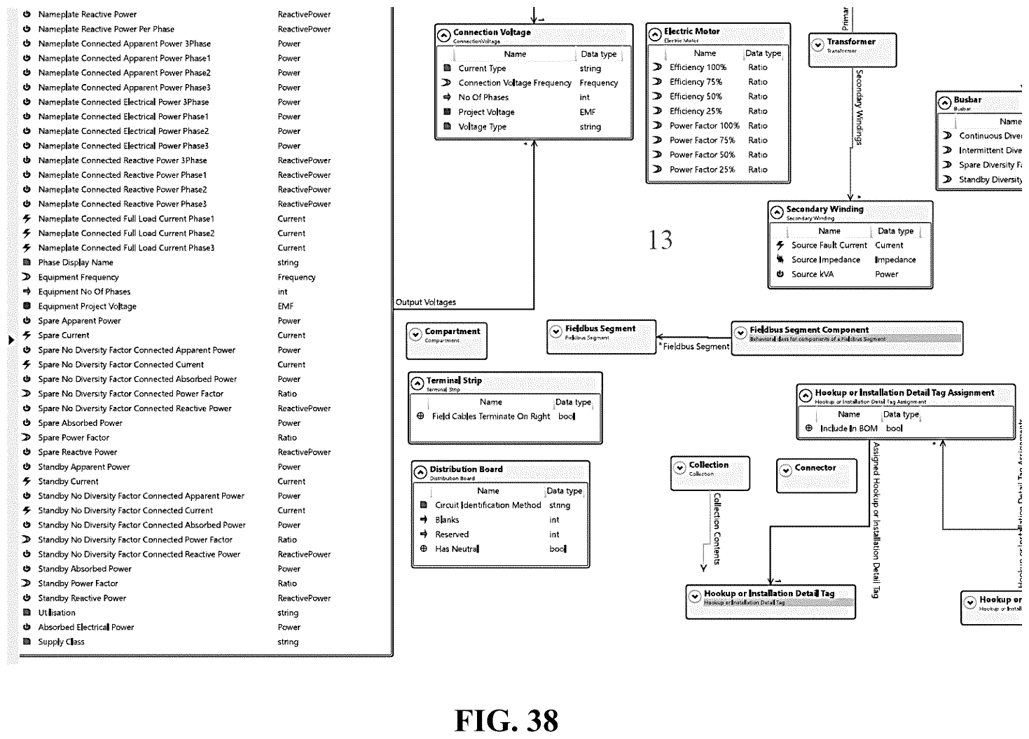

FIG. 38 illustrates section 13 of the vocabulary grid of FIG. 25 according to some embodiments.

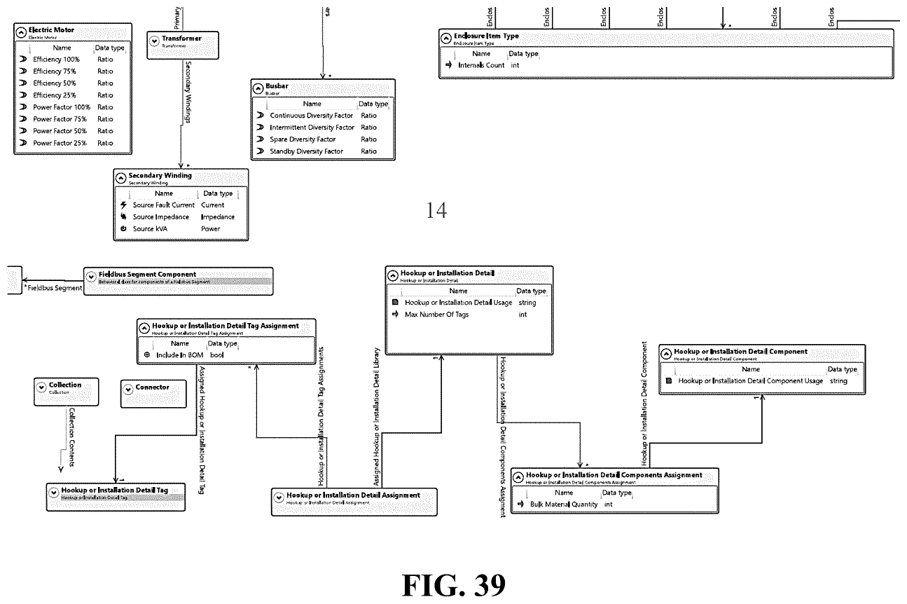

FIG. 39 illustrates section 14 of the vocabulary grid of FIG. 25 according to some embodiments.

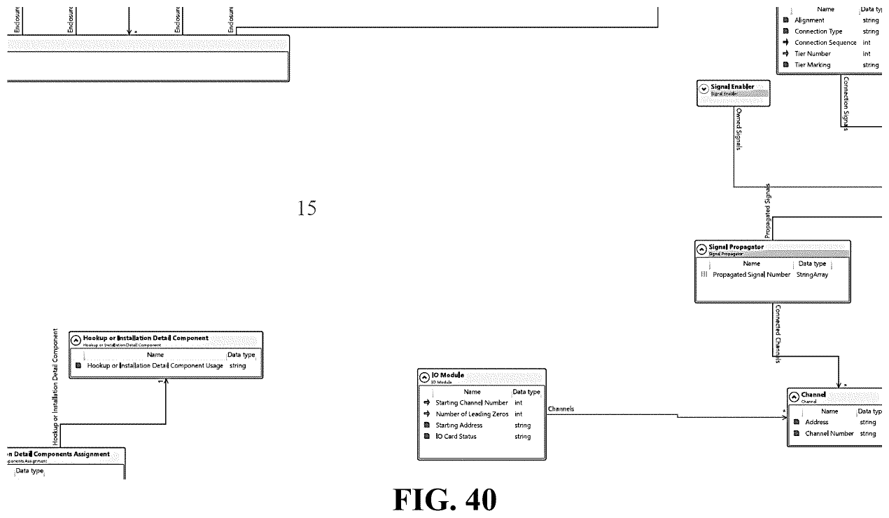

FIG. 40 depicts section 15 of the vocabulary grid of FIG. 25 according to some embodiments.

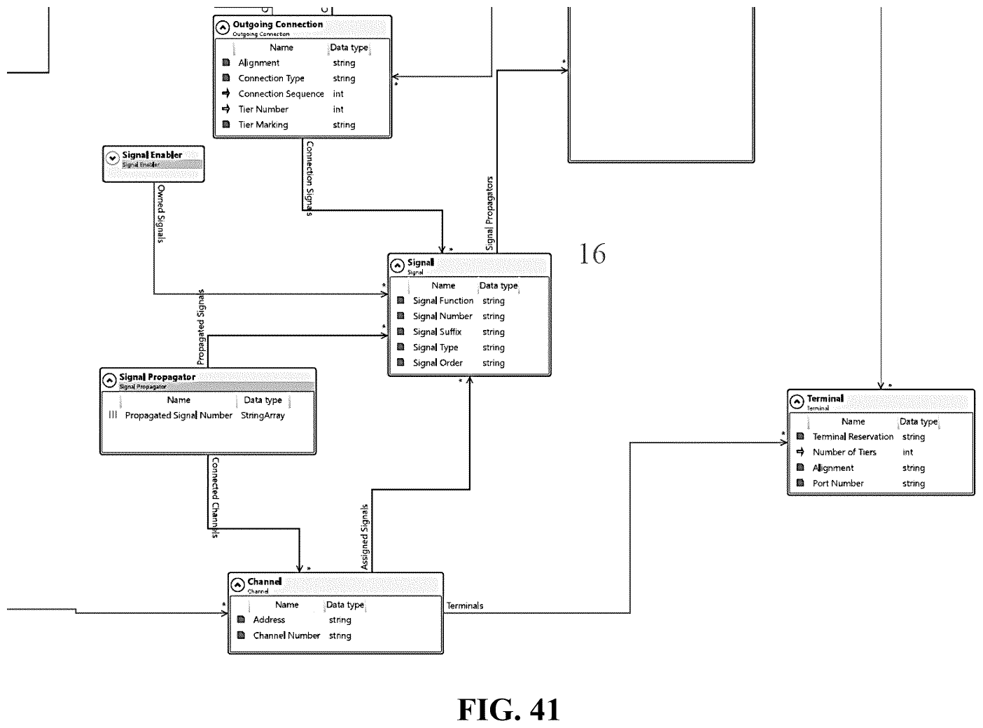

FIG. 41 illustrates section 16 of the vocabulary grid of FIG. 25 according to some embodiments.

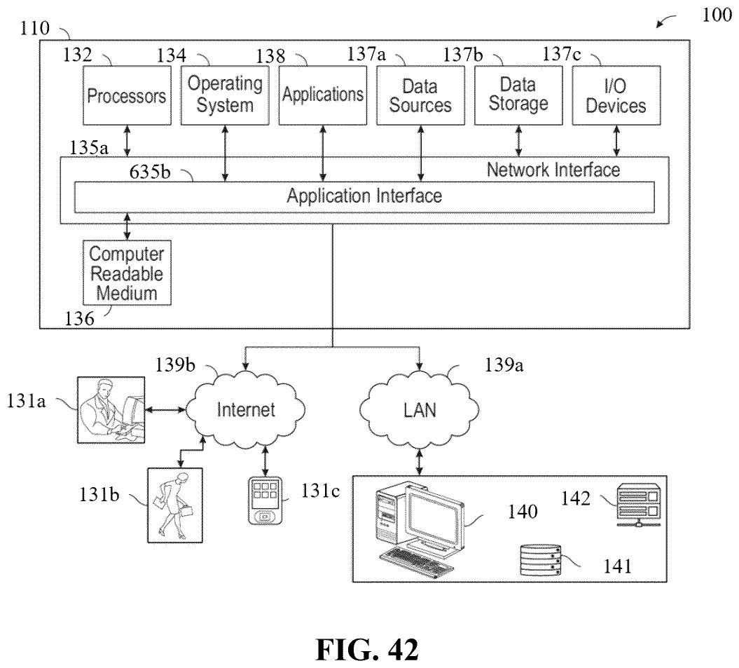

FIG. 42 illustrates a computer system enabling or comprising the systems and methods in accordance with some embodiments of the system.

### DETAILED DESCRIPTION OF THE INVENTION

In some embodiments, the system is configured to enable different engineers from the same or multiple disciplines to work on the same project by ensuring that proper connections are made between object entities in a design environment. In some embodiments, multiple standards across different disciplines and vendors cause confusion between disciplines. In some embodiments, different standards between countries due to different local laws and regulations are an example of where different standards can appear. In some embodiments, there are certain call functions that the software needs to be able to perform to adhere to the different standards that do not currently exist in prior art systems. In some embodiments, the system enables a link between editable data models and generic hard coded entities to create specific entities for a specific domain.

FIG. 1 illustrates general functionality employed by the system according to some embodiments. In some embodiments, the system is configured to solve domain specific problems, such as problems that arise with standards in electrical domains, mechanical domains, instrumentation domains, and the like, by enabling a user to define attributes such as standards in a data model.

In some embodiments, the system is configured to allow domain experts and/or developers to add and/or hard code ubiquitous language for an object entity and/or entity class for a domain. In some embodiments, the system is configured to enable a user to associate (decorate) the ubiquitous language using vocabulary that the design environment logic will work against. Design environment logic includes a part of a (software) platform programming that defines rules for how data is generated, saved, and/or changed, which includes how object entities interface with one another in the design environment according to some embodiments. In some embodiments, the system is configured to integrate vocabulary into the design environment that controls how the entities in the model interact with each other and/or what attributes (e.g., components, parts lists, connection diagrams, etc.) are associated with each entity. In some embodiments, this allows a customer to create a custom data model defining domain specific functionalities that are required for that domain. As used herein, entities include any visual and/or virtual representation of a real-world system component, signal, and/or process in a design environment. Examples may include pumps, fluid lines, electrical lines, signals (transitory and non-transitory), diagrams, drawings, specifications, schematics, items, and the like. Entities may also be referred to as objects and/or icons when establishing the metes and bounds of the system.

In the non-limiting example shown in FIG. 1, electrical engineering is the domain. In some embodiments, as shown in FIG. 1 a first step includes the system enabling a developer and/or domain expert to define the vocabulary and/or generic entities for a specific domain. In some embodiments, the domain vocabulary includes data models labeled with terms such as “cable” or “connector” which are hard-coded into the software and/or are loaded into the entity library at runtime. In some embodiments, the system will not let a first entity connect to a second entity that does not share a vocabulary link. In some embodiments, the system is configured to automatically assign one or more required vocabulary decorations to one or more connected generic entities once a connection to a specific entity is attempted in the design environment. In some embodiments, the system is configured to generate a notification of required decorations for entity connection. In some embodiments, the system is configured to enable a user to redefine generic entities and/or specific entities with new names or in new languages. While the name of the entity may change, the decorations that define the specific entities remain the same in some embodiments. In some embodiments, the system is configured to propagate a change in a generic entity, a specific entity (e.g., cable), a compatible entity (e.g., connector), a sub-entity (e.g., schematic), a vocabulary item, and/or a data model to propagate through the entire conceptual model without the need to change every instance of that entity in the design environment. Currently there is not a way for prior art platforms to recognize and/or associate new names with corresponding existing entities, as current platforms do not allow users to modify the hard coding of a rigid data model to include new functionality.

In some embodiments, the entity vocabulary can be defined in a vocabulary script and stored in a vocabulary module (also referred to herein as a library) in the design software. According to a method, a company providing the software for the system works with an administrator at a construction company to determine the entity vocabulary which generically describes all the (real-world) components that are to be used during construction. As shown in FIG. 1, step 2, an engineer at the construction company imports entities A (cable), B (cable catalog), and C (cable core) into a design environment as a conceptual model. At step 3, the entities are decorated with vocabulary, which defines the exact type of cable A used, along with its specific cable catalogue number B, and specific cable core C, creating specific entities that “speak” to each other. The generic entities have now been transformed into specific entities using the vocabulary decorations created by the user and assigned in the design environment. After these decorations are stored at step 4, when a connection is attempted between entities in the design environment the design environment logic automatically includes the attributes of the vocabulary wherever a cable entity is used, ensuring that only a specific cable and specific compatible cable components are used in the design, as opposed to a generic cable designation with no links that may accidently be misinterpreted at time of conceptual design.

FIGS. 2A-B show the vocabulary created and/or stored in an XML format script, as a non-limiting example according to some embodiments. In some embodiments, the vocabulary is configured to link specific entities together, where the design environment logic references the script to determine entity links to enforce and/or attributes to add to generic entities through assigned vocabulary. In some embodiments, the system is configured to enable generic entities not to bound by the vocabulary to act in a generic fashion within the development environment, which may include generic links (e.g., connecting lines). In some embodiments, the system is configured to propagate and or assign vocabulary to one or more generic entities connected by one or more generic links based on the decoration of a single generic link with a vocabulary item. In some embodiments, the vocabulary causes the design environment logic to only allow connections between specific entities, and/or auto populates what additional elements are required in the design to properly make the connection between a specific entity and a generic entity according to some embodiments. In some embodiments, this prevents a scenario where parts are missing or mismatched during construction of the actual system, which is a current problem in the art resulting in lost time and/or money.

FIG. 3 depicts an XML viewer graphical rendering of the XML script in FIGS. 2A-B according to some embodiments. In some embodiments, the graphical rendering is not a model in itself, but illustrates the links between specific entities and/or the vocabulary the design environment logic references and enforces. In some embodiments, this example shows dozens of specific entities for a cable system: a manufacturing facility model may have many thousands of specific entities. Specific entities, also referred to as classes herein, are representations of a component type (e.g., valve, gasket, pump, cable, junction box, connector etc.) defined by a generic entity and the details of a specific component defined by the vocabulary decoration. In some embodiments, the vocabulary provides a method for a developer to adjust a generic entity to include specific vocabulary that only allows connection to another entity if specific conditions defined by the vocabulary decoration are met. In some embodiments, the boxes in FIG. 3 represent the different specific entities, where the text within the boxes represent various vocabulary items that decorate the generic entities transforming them to specific entities. In some embodiments, the map represents a network of how all the various specific entities are related.

FIG. 4 is a zoomed view on the cable portion of the viewer map rendering of FIG. 3 according to some embodiments. In some embodiments, the cable entity includes all the associated vocabulary in the form of the attributes listed under name and data type that the design environment logic needs to function. In some embodiments, the arrows leading to and/or from the cable entity are the associated links to other classes. Most the attributes of the vocabulary items have to do with sizing and installation in this non-limiting example according to some embodiments.

Referring back to FIG. 1, in some embodiments, step 2 includes a project modeler defining attributes for a data model in the design environment, which is further illustrated in FIGS. 5-13 according to some embodiments. It is understood descriptions of one or more graphical user interfaces (GUIs) generated by the system do not require written descriptions when defining the metes and bounds for protection sought as the features are present in the drawings. For example, a description of FIG. 5 can include a recitation that the system is configured to display a design environment for importing entities and/or vocabulary, and/or that the system is configured to display a class panel comprising one or more of class attributes, class associations, and class vocabulary.

In some embodiments, the system is configured to enable a user to define (e.g., rename) each generic (e.g., A, B, and C) entity in the conceptual model as whatever they choose. A third step in a method of use and/or manufacture includes assigning the vocabulary to the project by decorating the generic entities in the conceptual model with vocabulary items. In some embodiments, the system is configured to link the decorations to the design environment logic, so that the design environment model is able to recognize the decorations. In some embodiments, the system is configured to validate the conceptual model to make sure the conceptual model has everything it needs by comparing the entity decorations to the vocabulary script (and/or map). In some embodiments, the system is configured to generate a report of items missing in the conceptual model if all the requirements of the vocabulary are not met for one or more entities. In some embodiments, a fourth step includes building and/or storing the validated data model and instances of the decorated entities.

In some embodiments, what is included in the vocabulary can be determined during the design phase of a system configuration for a particular customer. For example, before an electrical generating facility is built, various teams will be working on different components of the plant. A particular turbine generator may have electrical sensors, where each sensor has a particular connection wire that terminates in a specific type of junction box using a specific type of connection end. The supervisory control and data acquisition system may have electrical cables using another type of connector at the computer side and yet another different connector at the junction box where it interfaces with the sensor. As is evident, complexity can be ever increasing, and it is easy to miss one or two seemingly miniscule elements when connecting various components together in a conceptual model. However, by including all possible connection and interface standards for each generic entity in vocabulary, the system is able to verify all correct standards are being implemented once a specific vocabulary item is associate with a generic entity creating a specific entity. Therefore, the system ensures that every element is accounted for in the design phase, which prevents having to redesign or order parts during installation.

Prior art systems only have fixed data models that do not allow for this level of customization. Using cables as an example, in prior art system the generic entity may be labeled “cable” but there may also be several other entities with the same “cable” designation, which could even be in multiple languages. Determining which “cable” is appropriate to use to connect entities is not evident within prior art systems. In contrast, the system described herein is configured to decorate each generic entity with specific vocabulary items. This way, the design environment logic always knows what to do with an entity that has been decorated with specific vocabulary. In some embodiments, the system is configured to prevent the use of a generic entity that has not be decorated with specific vocabulary, thereby enforcing the design environment logic. In some embodiments, the system is configured to prevent the connection of two decorated entities that are not a match and/or have not satisfied all attribute connections. In some embodiments, the system is configured to generate a graphical user interface showing one or more attribute connections and/or enabling a user to designate attribute connections within the model.

FIG. 5 illustrates the second step being implemented in a design environment on a GUI according to some embodiments. In some embodiments, the vocabularies from step 1 are shipped with the generic modeling software product. In some embodiments, the system is configured to generate a display comprising a GUI showing the active vocabularies generated in step 1. In some embodiments, the GUI is configured to enable a user to select one or more vocabularies to interface with generic entities in the design environment logic.

FIG. 6 shows a display comprising a GUI that includes the design environment according to some embodiments. In some embodiments, the cable oval icon represents a generic entity, which in itself does not include the vocabulary pre-decoration. However, the two different color dots at the bottom right of the cable entity indicates that the generic cable entity has been decorated with vocabulary according to some embodiments, resulting in a specific entity. In some embodiments, the GUI includes a vocabulary section comprising a vocabulary item section (far right bottom panel) which is configured to list the available vocabulary items when the cable entity is selected.

FIG. 7 depicts a scenario where the name of the decorated specific cable entity has been changed and also a new specific cable entity has been added according to some embodiments. In some embodiments, although the name of the decorated cable entity has been changed to Cable 123, and a new cable entity has been named Japanese Cable, both have the same cable decoration from the vocabulary, so the design environment logic knows to treat them the same. In some embodiments, the system is configured to propagate a specific entity name change to one or more specific entities with matching vocabulary. This precludes a need for the vendor to have to do a fundamental redesign of the software to account for each new naming convention as the vocabulary defines the properties for each generic entity, saving time and resources.

Referring still to FIG. 7, in some embodiments the system is configured to generate an input to enable a user to validate the vocabulary. In some embodiments, the execution of the validation causes the system to refer to the vocabulary script/map and recommend one or more specific entities and/or vocabulary additions to form proper links in the conceptual model. In some embodiments, the system is configured to automatically add the missing entities in the conceptual model to one or more generic and/or specific entities. In some embodiments, the system is configured to decorate one or more entities with the proper vocabulary as determined by the vocabulary map.

For example, Cable 123 must have an association link with cable glands, which are the connectors at the end of a cable according to some embodiments. In some embodiments, a cable comprises a grouping of cores (wires). As in the vocabulary graphical representation shown in FIG. 1, the vocabulary includes cable cores as part of the cable decoration, so any entity labeled as a cable in the conceptual environment is required to also have a cable core entity, which the system may automatically provide to the conceptual model in the design environment (along with one or more other required specific entities) according to some embodiments. In some embodiments, the system is configured to generate a display comprising a list of associated specific entities.

This functionality also allows for better interaction between cross-disciplines according to some embodiments. For example, a mechanical engineer decorating a generic entity as a pump causes the system to automatically pull in the associated electrical entities (motors, wiring, sensors, etc.), so that those items are already present in the conceptual model when an electrical engineer needs to adjust and/or add to the conceptual model by, for example, making a connection from the pump motor entity to an instrumentation entity. In some embodiments, the system is configured to enable vocabulary for any type of modeling software such as P&ID and chemical system modeling.

FIG. 8 shows the storage model generated by the system after vocabulary validation according to some embodiments. In some embodiments, the system is configured to generate one or more user defined data models (left column) in the storage model, which includes cableUDET for Cable 123 in this non-limiting example. In some embodiments, selection of data model element in the list is configured to generate a data model element editor as shown in FIG. 8.

FIG. 9 depicts an engineering environment portion of the system according to some embodiments. In some embodiments, the engineering environment comprises one or more grids from the project. In some embodiments, the system is configured to generate a list view of the grid class when the grid class is selected in the engineering environment. In some embodiments, the grid class includes details of the vocabulary and/or connections for an entity in the design environment.

FIG. 10 illustrates the expansion of a generic entity class in the conceptual environment to display subclasses according to some embodiments. In some embodiments, the subclasses may also be cable entities, but may contain extra properties. In some embodiments, the system is configured to automatically propagate the decorations from a parent class to each subclass. An example where this may be useful is when there is more than one type of cable suitable for a particular application, where the designer wishes to indicate the choice for cost considerations or availability at the time of construction. In some embodiments, the system is configured to enable the design environment logic to prioritize the limitations and/or decorations of the vocabulary for a specific entitiy over the generic entities during runtime.

FIG. 11 illustrates the system generating a new tab (ribbon) when a specific cable from the engineering environment is selected according to some embodiments. In some embodiments, because the specific entity has been decorated as a cable, selection of any specific cable sub-entity in the design environment logic propagates to the parent entity as well. In some embodiments, the system is configured to generate a new tab (e.g., cables tab) in the engineering environment upon selection of a decorated specific entity. In some embodiments, the system is configured to generate one or more icons and/or one or more links in the new entity tab that is specific to the functionality of the decoration. For example, as shown in FIG. 11, the new entity tab “Cables” has new links such as Glands, Gland Adaptor, Cable to Gland, etc. in the header. Referring back to FIG. 1, the graphical representation shows a Cable Catalog Number (No.) entity connected to Cable. In some embodiments, this is configured to establish a link in the design environment where selection of the Catalog Item link in the new tab brings up a list of all cable catalog items that can be used in the project. In some embodiments, after selection of a cable catalog item, the system is configured to automatically import all the associated attributes such as cable cores into the model and link them together with the design environment logic and/or the vocabulary.

In some embodiments, the new entity tab comprises one or more links for terminating cables, such as a termination from link, as a non-limiting example. In some embodiments, selection of the (termination from) link generates a link editor. In some embodiments, as shown in FIG. 11, the cable may have a junction box, and selection of the terminations from link opens the junction box entity which is also part of the vocabulary.

FIG. 12 depicts a GUI displaying the terminations editor according to some embodiments. In some embodiments, the system is configured to generate a GUI comprising one or more entity attributes from one or more specific entities defined with the vocabulary. In some embodiments, as in this non-limiting example, the GUI displays a cable sizing window, termination junctions in the junction box, and a list of the different cores for the cable. In some embodiments, the system is configured to enable a user to drag an entity attribute from an entity (class) to another entity (e.g., core to terminal junction) to create a link between the two.

FIGS. 13A-D show the 1Rd from the Cores Window in FIG. 12 being terminated onto a terminal in the junction box according to some embodiments. In some embodiments, once an association from attributes from one entity are assigned to the other entity, the system is configured to remove availability to repeat the use of the attribute (e.g., 1Rd is removed from the Cores list grid).

In some embodiments, the system is configured to cause the design environment logic to interface with the vocabulary. In some embodiments, the system is configured to enable a user to decorate generic entities with vocabulary. In some embodiments, the system is configured to store the decorations for a cable in a library and/or list. In some embodiments, the system is configured to automatically populate decorated entities with attributes from the vocabulary. In some embodiments, the system is configured to generate a GUI enabling a user to make connections between attributes in different vocabularies using the design environment logic. In some embodiments, the system is configured to automatically pull information such as attributes and/or sub-entities from one or more connected specific entities and display them on a GUI. In some embodiments, the system is configured to generate a visual difference between vocabulary types (e.g., mechanical vs electrical) on the GUI. In some embodiments, each direction on a class further adds attributes to each class that need to be addressed.

FIG. 14 illustrates a first step of a method for implementing the system according to some embodiments. In some embodiments, a first step includes generating a conceptual environment and enabling a vocabulary script.

FIG. 15 illustrates a second step of a method for implementing the system according to some embodiments. In some embodiments, a second step includes validating the vocabulary in the vocabulary script to produce a data model. In some embodiments, a step includes generating one or more entities and decorating the one or more entities with one or more vocabulary items. In some embodiments, a step includes generating an association between the entities (classes) and the vocabulary items.

FIG. 16 shows a third step of a method for implementing the system according to some embodiments. Some embodiments include a step of building and/or storing the model to generate UDETs and UDAs (Universal Data Access). In some embodiments, a step includes generating a reference UDA as a representation between entities.

FIG. 17 depicts a fourth step of a method for implementing the system according to some embodiments. Some embodiments include a step of writing and/or modifying design environment logic to use the vocabulary script as a map between entities in the data model.

FIG. 18 depicts a fifth step of a method for implementing the system according to some embodiments. Some embodiments include a step of executing the system to generate one or more GUIs where one or more first attributes of a first specific entity can be associated and/or linked with one or more second attributes of a second specific entity.

FIG. 19 shows a sequence diagram for implementing the system on a cable class according to some embodiments. Design environment logic and business logic may be used interchangeably herein.

FIG. 20 illustrates a non-limiting example vocabulary links for an engineering and instrumentation (E&I) class according to some embodiments. In Engineering, selection of an clement triggers design environment logic that checks for any vocabulary decorations on the entity object in some embodiments. In some embodiments, if the decoration has certain special logic attached to it, then that logic is executed. For example, in some embodiments, when a user selects an entity whose actual type is ‘:Cable,’ the design environment logic will query a Data model API for decorations of ‘:Cable’ in the vocabulary script. In some embodiments, the Data model API navigates the script network and finds that ‘:Cable’ has been generated from conceptual model class ‘Cable’ and conceptual model class ‘Cable’ is decorated with vocabulary class ‘Cable’. In some embodiments, when the design environment logic identifies that selected element is of type ‘Cable’ from the E&I vocabulary, it presents the user with all E&I functionality related to a cable and associates it with the specific entity.

In some embodiments, vocabulary provides the structure for design environment logic to enable design environment rules. In some embodiments, the design environment logic is programmed against vocabulary in the same way it would be programmed against a fixed schema in any database. For example, in some embodiments, when a Cable Catalog No. is assigned to a Cable then the design environment logic executes: (A) Cable Cores creation as per the definition of Cable Catalog assigned to the Cable; and (B) automatic association of newly created Cable Cores to their respective Cable Core Catalog No.

FIG. 21 shows the addition of a Cables ribbon (tab) when an element of type “cable” is selected according to some embodiments. FIG. 22 shows removal of a Cables ribbon (tab) when an element other than a type “cable” is selected according to some embodiments.

In some embodiments, at the startup of an Engineering application software, design environment logic queries a data model API to give it the UDA that represents “Cable Catalog No” association and attaches a listener to any requests for a reference browser for this UDA. In some embodiments, when user requests reference browser for UDA that represents “Cable Catalog No” association, they are presented with a “Cable Catalog” selection dialog instead of the standard reference browser. In some embodiments, the system is configured to enable a user to select a Catalog item from the list presented in the overridden reference browser. At this point design environment logic intercepts the selected catalog item and queries the Catalog database to get the list of Catalog Cores of the selected Cable from catalog according to some embodiments.

In some embodiments, for each “Catalog Core” in the list a “Cable Core” is created and associated to its respective “Catalog Core” via “Cable Core Catalogue No” association. Next, in some embodiments, all newly created Cable Cores are associated to the Cable via the “Cores” association. In some embodiments, this is all possible because design environment logic is programed to the vocabulary structure and uses this prior knowledge as guidance to navigate the conceptual model via Data model API. In some embodiments, the design environment logic has prior knowledge that a Cable class will have associations to Cable catalog and Cable cores, where Cable Core will have an association to Core Catalog, and based on this knowledge the design environment logic queries the conceptual model via Data model API to find the UDAs for these associations and then finds the correct UDETs for these classes, instantiates instances of the UDETs and set them as reference in correct UDA. FIG. 23 depicts a “Cable Catalog No” reference number selection button according to some embodiments. FIG. 24 shows the Cable Catalog reference browser according to some embodiments.

FIG. 25 illustrates the non-limiting example cable vocabulary map sectioned into a grid according to some embodiments. FIG. 26 shows section 1 of the vocabulary grid of FIG. 25 according to some embodiments. FIG. 27 depicts section 2 of the vocabulary grid of FIG. 25 according to some embodiments. FIG. 28 shows section 3 of the vocabulary grid of FIG. 25 according to some embodiments. FIG. 29 illustrates section 4 of the vocabulary grid of FIG. 25 according to some embodiments. FIG. 30 depicts section 5 of the vocabulary grid of FIG. 25 according to some embodiments. FIG. 31 depicts section 6 of the vocabulary grid of FIG. 25 according to some embodiments. FIG. 32 shows section 7 of the vocabulary grid of FIG. 25 according to some embodiments. FIG. 33 illustrates section 8 of the vocabulary grid of FIG. 25 according to some embodiments. FIG. 34 illustrates section 9 of the vocabulary grid of FIG. 25 according to some embodiments. FIG. 35 shows section 10 of the vocabulary grid of FIG. 25 according to some embodiments. FIG. 36 depicts section 11 of the vocabulary grid of FIG. 25 according to some embodiments. FIG. 37 shows section 12 of the vocabulary grid of FIG. 25 according to some embodiments. FIG. 38 illustrates section 13 of the vocabulary grid of FIG. 25 according to some embodiments. FIG. 39 illustrates section 14 of the vocabulary grid of FIG. 25 according to some embodiments. FIG. 40 depicts section 15 of the vocabulary grid of FIG. 25 according to some embodiments. FIG. 41 illustrates section 16 of the vocabulary grid of FIG. 25 according to some embodiments.

FIG. 42 illustrates a computer system 110 enabling or comprising the systems and methods in accordance with some embodiments of the system. In some embodiments, the computer system 110 can operate and/or process computer-executable code of one or more software modules of the aforementioned system and method. Further, in some embodiments, the computer system 110 can operate and/or display information within one or more graphical user interfaces (e.g., HMIs) integrated with or coupled to the system.

In some embodiments, the computer system 110 can comprise at least one processor 132. In some embodiments, the at least one processor 132 can reside in, or coupled to, one or more conventional server platforms (not shown). In some embodiments, the computer system 110 can include a network interface 135a and an application interface 135b coupled to the least one processor 132 capable of processing at least one operating system 134. Further, in some embodiments, the interfaces 135a, 135b coupled to at least one processor 132 can be configured to process one or more of the software modules (e.g., such as enterprise applications 138). In some embodiments, the software application modules 138 can include server-based software, and can operate to host at least one user account and/or at least one client account, and operate to transfer data between one or more of these accounts using the at least one processor 132.

With the above embodiments in mind, it is understood that the system can employ various computer-implemented operations involving data stored in computer systems. Moreover, the above-described databases and models described throughout this disclosure can store analytical models and other data on computer-readable storage media within the computer system 110 and on computer-readable storage media coupled to the computer system 110 according to various embodiments. In addition, in some embodiments, the above-described applications of the system can be stored on computer-readable storage media within the computer system 110 and on computer-readable storage media coupled to the computer system 110. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 110 can comprise at least one computer readable medium 136 coupled to at least one of at least one data source 137a, at least one data storage 137b, and/or at least one input/output 137c. In some embodiments, the computer system 110 can be embodied as computer readable code on a computer readable medium 136. In some embodiments, the computer readable medium 136 can be any data storage that can store data, which can thereafter be read by a computer (such as computer 140). In some embodiments, the computer readable medium 136 can be any physical or material medium that can be used to tangibly store the desired information or data or instructions and which can be accessed by a computer 140 or processor 132. In some embodiments, the computer readable medium 136 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 136 can transmit or carry instructions to a remote computer 140 and/or at least one user 131, including a router, private or public network, or other transmission or channel, both wired and wireless. In some embodiments, the software application modules 138 can be configured to send and receive data from a database (e.g., from a computer readable medium 136 including data sources 137a and data storage 137b that can comprise a database), and data can be received by the software application modules 138 from at least one other source. In some embodiments, at least one of the software application modules 138 can be configured within the computer system 110 to output data to at least one user 131 via at least one graphical user interface rendered on at least one digital display.

In some embodiments, the computer readable medium 136 can be distributed over a conventional computer network via the network interface 135a where the system embodied by the computer readable code can be stored and executed in a distributed fashion. For example, in some embodiments, one or more components of the computer system 110 can be coupled to send and/or receive data through a local area network (“LAN”) 139a and/or an internet coupled network 139b (e.g., such as a wireless internet). In some embodiments, the networks 139a, 139b can include wide area networks (“WAN”), direct connections (e.g., through a universal serial bus port), or other forms of computer-readable media 136, or any combination thereof.

In some embodiments, components of the networks 139a, 139b can include any number of personal computers 140 which include for example desktop computers, and/or laptop computers, or any fixed, generally non-mobile internet appliances coupled through the LAN 139a. For example, some embodiments include one or more of personal computers 140, databases 141, and/or servers 142 coupled through the LAN 139a that can be configured for any type of user including an administrator. Some embodiments can include one or more personal computers 140 coupled through network 139b. In some embodiments, one or more components of the computer system 110 can be coupled to send or receive data through an internet network (e.g., such as network 139b). For example, some embodiments include at least one user 131a, 131b, is coupled wirelessly and accessing one or more software modules of the system including at least one enterprise application 138 via an input and output (“I/O”) 137c. In some embodiments, the computer system 110 can enable at least one user 131a, 131b, to be coupled to access enterprise applications 138 via an I/O 137c through LAN 139a. In some embodiments, the user 131 can comprise a user 131a coupled to the computer system 110 using a desktop computer, and/or laptop computers, or any fixed, generally non-mobile internet appliances coupled through the internet 139b. In some embodiments, the user can comprise a mobile user 131b coupled to the computer system 110. In some embodiments, the user 131b can connect using any mobile computing 131c to wireless coupled to the computer system 110, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of process modeling by enabling a hard coded software access and implement an external vocabulary script to control design environment logic. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tic-up a judicial exception with known conventional steps implemented by a general-purpose computer; nor do they attempt to tic-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, clement B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, clement C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system comprising:
one or more computers comprising one or more processors and one or more non-transitory computer readable media, the one or more non-transitory computer readable media including program instructions stored thereon that when executed cause the one or more computers to:
generate, by the one or more processors, a design environment, the design environment configured to enable a user to create a model of an industrial process using one or more entities;
generate, by the one or more processors, an entity library comprising one or more generic entities, the one or more generic entities each comprising a visual representation of a generic attribute associated with the industrial process;
generate, by the one or more processors, a vocabulary library comprising one or more vocabulary items, the one or more vocabulary items each comprising a visual representation of a data model; and
execute, by the one or more processors, an association between the one or more vocabulary items and the one or more generic entities in the design environment to create specific entities;
wherein each data model comprises one or more attributes; and
wherein the design environment is configured to compare one or more attributes between specific entities when a link between the specific entities is attempted in the design environment.

2. The system of claim 1,
wherein the data model is configured to be edited by the user.

3. The system of claim 2,
wherein editing the data model includes adding the one or more attributes to the data model.

4. The system of claim 1,
wherein the design environment is configured to prevent a link between specific entities that do not share the one or more attributes.

5. The system of claim 1,
wherein the design environment is configured to prevent a link between specific entities and generic entities.

6. The system of claim 1,
wherein the design environment is configured to automatically assign one or more vocabulary items to a generic entity when a link between a specific entity and the generic entity is attempted.

7. The system of claim 1,
wherein the design environment is configured to enable links between a first generic entity and a second generic entity.

8. The system of claim 7,
wherein the one or more non-transitory computer readable media further include program instructions stored thereon that when executed cause the one or more computers to:
execute, by the one or more processors, an association of one or more vocabulary items to the second generic entity automatically when at least one vocabulary item is associated with the first generic entity.

9. The system of claim 1,
wherein a visual representation of a generic entity includes a generic entity icon; and
wherein a visual representation of a vocabulary item includes a vocabulary item icon.

10. The system of claim 9,
wherein the one or more non-transitory computer readable media further include program instructions stored thereon that when executed cause the one or more computers to:
execute, by the one or more processors, a visual representation of a specific entity in the design environment.

11. The system of claim 10,
wherein the visual representation of the specific entity includes an overlay of the vocabulary item icon on the generic entity icon in the design environment.

12. The system of claim 1,
wherein attributes include one or more details about one or more of a component, a signal, a schematic, and/or a process associated with the industrial process.

13. The system of claim 1,
wherein the system is configured to enable a user to execute a name change for a specific entity.

14. The system of claim 13,
wherein the system is configured to propagate the name change to other specific entities that share one or more same vocabulary items.

15. The system of claim 1,
wherein the system is configured to limit a display of generic entities in the entity library and/or vocabulary items in the vocabulary library to a particular domain.
